(19) United States
(12) Patent Application Publication
(10) Pub. No.: US 2005/0120811 A1
(43) Pub. Date: Jun. 9, 2005

(54) Method and apparatus for characterizing weathering reciprocity of a material

(76) Inventor: Henry K. Hardcastle III, Sunrise, FL (US)

Correspondence Address: Michael J. Turgeon;VEDDER PRICE KAUFMAN & KAMMHOLZ, 24TH FLOOR, 222 N. LASALLE STREET, CHICAGO, IL, 60601, US

(21) Appl. No.: 10/726,425

(22) Filed: Dec. 3, 2003

(51) Int. Cl. G01N 17/00

(52) U.S. Cl. 73/865.6; 374/57

(57) ABSTRACT

An assembly for characterizing weathering reciprocity of a material includes an array of natural accelerated weathering test apparatus of the type used to concentrate solar radiation upon test specimens formed from the material. Each natural accelerated weather and test apparatus includes a temperature control system for maintaining the test specimens at a desired temperature. The plurality of sets of natural accelerate weathering test apparatus are defined within the array and the test specimens are exposed to a different solar radiation intensity.

### FIELD OF THE INVENTION

The present invention relates generally to accelerated weathering test devices of the type used to expose test specimens to solar radiation and other weathering effects on an accelerated basis, and, more particularly, to a method for characterizing weathering reciprocity of a material.

### BACKGROUND OF THE INVENTION

Manufacturers of exterior coatings, such as paints and finishes, as well as plastics and other components that tend to degrade under exposure to solar radiation and other weathering effects, want to know how such products will perform following years of exposure while in service. However, such manufacturers typically require results and data in a much shorter time period than is necessary to expose such materials to weathering effects under normal generating conditions. Accordingly, accelerated weathering test devices have been developed that accelerate the effects of weathering due to outdoor exposure in a much shorter time period. As a result, manufacturers do not have to actually wait five or ten years in order to determine how their products will hold up after five or ten years of actual outdoor exposure.

The ability to ascertain a material's weathering reciprocity or conversion factor is very important in weathering technology. A proper conversion factor must be applied to the raw accelerated test results in order to derive the natural degradation rate useful to predict material weathering service life in natural, unaccelerated conditions. The concept of reciprocity is that a material should weather at a rate based on the time of exposure and the density level of exposure. Theoretically, an exposure of a sample for a set period of time at one level of exposure should result in an amount of weathering as would be obtained by an exposure for half the time and twice the intensity. This theoretical reciprocity, however, is usually not observed in practice and conclusions based thereon are often incorrect.

A proper conversion factor may be different for different levels of light amplification used for acceleration. The proper conversion factor also may vary as a complex function of light intensity, exposure temperature and ultraviolet spectral power distribution interactions, either synergistically or antagonistically. Moreover, a proper conversion factor also may be different for different materials, different formulations of the same paint or plastic, different processing conditions used to produce the same formulation, variations in raw materials and other variations. For these reasons, it is important to have a method to accurately determine the weathering reciprocity or correlation factor of a material.

Prior art characterizations of weathering reciprocity of a material are solely dependent on artificial light sources such as xenon arc, metal halide and fluorescent sources. Material test specimens are exposed to these light sources in an environmentally controlled chamber. The intensity of the light source is varied and the degradation of the material test specimen is plotted as a function of the intensity. Separate experiments may be carried out varying the temperature of the test specimens by altering the intensity of the exposure. These factors have not been varied in combination to understand the interactions.

An example of an indoor or artificial accelerated weathering test device is disclosed in U.S. Pat. No. 3,664,188 issued to Kockott. While such test devices have the advantage of permitting precise control over radiation intensity, temperature and humidity, such test devices fail to duplicate the actual light spectrum of natural sunlight to which the specimens under test will actually be exposed in everyday use. It has been acknowledged and recognized by those of skill in the art that natural sunlight and artificial sunlight accelerated weathering test apparatus are not only structurally and functionally distinct, but also provide different sets of empirical data.

The spectral power distribution of artificial light sources is significantly different than natural sunlight. The unnatural spectra of artificial light sources introduce differences in the photochemistry of degradation as compared with natural light sources. Consequently, using artificial light sources to characterize the intensity/time relationship (or weathering reciprocity of a material) introduces additional variables that may confound the data. Artificial light sources also require extensive and costly modification in order to more closely simulate spectral power distributions found in natural sunlight. The modifications also require significant maintenance and replacement, which also introduces errors in the reciprocity characterization.

Outdoor or natural accelerated weathering test devices have been used for degradation of material. However, no method has been developed in the prior art to characterize reciprocity relationships using outdoor accelerated weathering test apparatus. The use of outdoor accelerated weathering test apparatus in the prior art typically involves a simple correlation between accelerated test results from the device to results obtained from real outdoor exposures. This simple approach provides a “spot check” in a single conversion factor to relate a single set of accelerated intensities to real time exposures. However, simple correlation to real time does not characterize the intensity/time relationships or reciprocity with any degree of accuracy.

One of the earlier accelerated weathering test device is disclosed in U.S. Pat. No. 2,945,417, issued to Caryl et al. (the '417 patent), which includes a Fresnel-reflecting solar concentrator having a series of ten flat mirrors that focus natural sunlight onto a series of test specimens secured to a target board. The Fresnel-reflecting solar concentrator directs solar radiation onto the target board area with an intensity of approximately eight suns. Both the bed, which supports the mirrors of the solar concentrator, and the target board are supported by a frame, which can be rotated to follow daily movements of the sun. A solar tracking mechanism, responsive to the position of the sun, controls the operation of an electric motor, which is used to rotate the test apparatus to follow movements of the sun. The axis of rotation of the test machine is oriented in a north-south direction, with the north elevation having altitude adjustment capability to account for variation in the sun's altitude at various times during the year.

Such known testing devices are also commonly provided with an air tunnel mounted above the target board. An air deflector causes air escaping from the air tunnel to be circulated across the test specimens mounted to the target board to prevent the test specimens from overheating due to the concentrated solar radiation to which they are exposed. The amount of air is controlled by the dimension of the gap between the deflector and the specimen. A squirrel cage blower communicates with the air tunnel for blowing cooling ambient air therethrough. In addition, water spray nozzles are provided proximate to the target board for wetting the test samples at periodic intervals to simulate the weathering effects of humidity, dew, rain, etc.

Another known accelerated weathering test device is disclosed in U.S. Pat. No. 4,807,247, issued to Robins, III (the '247 patent), which includes all the structure previously described above with respect to the '417 patent and further includes a system for maintaining a uniform, constant test specimen temperature during daylight hours, despite variations in ambient air temperature and variations in solar radiation intensity.

The device of the '247 patent includes a temperature sensor mounted to the target board for exposure to the concentrated solar radiation and for generating a signal indicative of the temperature of the test specimen mounted to the target board. The system further includes a control mechanism operatively associated with the temperature sensor and responsive to the signal generated thereby for selectively controlling the application of electrical power to the electrical motor included within the air circulation system. In this manner, the control mechanism serves to vary the speed of the electric motor and thereby control the flow rate of cooling ambient air circulating across the target board so that the temperature of the test specimen remains constant at the desired set point.

When the sensed temperature of the test specimen in the '247 patent increases, the control mechanism increases the speed of the blower motor to circulate more cooling ambient air across the target board in order to lower the temperature of the test samples back to the desired set point. Similarly, if the sensed temperature of the target samples drops below the desired nominal temperature, the control mechanism decreases the speed of the blower to permit the test samples to warm up back to the desired set point.

The temperature control mechanism of the '247 patent also includes a user-operable adjustment mechanism, in the form of the control knob, for allowing a user to set a static, desired target specimen temperature. A bypass switch is also provided for allowing the user to operate the test device in the controlled-temperature mode, as described above, or in an uncontrolled mode wherein the blower motor operates at a constant speed.

Standardized testing methods have been developed for operating natural or artificial accelerated weathering test devices of the type described above. The American Society for Testing and Materials (ASTM) has issued standards G90, E838, D4141, D3105, D3841, D5105, E1596 and D4364 covering the testing procedures and the operating parameters for conducting such outdoor accelerated weathering tests. Other standards and appraisals have also been developed and specified by the Society of Automotive Engineers (SAE), Ford, International Standards Organization (ISO), American National Standards Institute (ANSI), Japan Industrial Standard (JIS), namely, SAE J576, SAE J1961, Ford EJB-M1J14-A, Ford EST-M5P11-A, ISO 877, ANSI/NSF 54, JIS Z 2381 and MIL-T-22085D.

Outdoor accelerated weathering test devices of the type described above in regard to the '417 and '247 patents have the advantage of using natural sunlight; hence, the specimens under test are exposed to the actual spectrum of sunlight. However, disadvantages of outdoor accelerated weathering test devices have been discovered. One such disadvantage is that test results obtained from an outdoor accelerated weathering test apparatus without temperature control have varying levels of repeatability or reproductability. Another disadvantage is that test results obtained from an outdoor accelerated weathering test apparatus having a static temperature control have varying levels of repeatability or reproductability.

Ultraviolet cut-off filters have been used in connection with accelerated weathering test apparatus in the prior art. However, there has been no prior art effort to quantify the effect of different wavelengths of ultraviolet radiation on the reciprocity relationship of the weathering degradation of a material using natural sunlight. This information is important, however, since artificial light source devices currently used to accelerate weathering of materials and make inferences regarding outdoor/natural service life with no knowledge of how different wavelengths of ultraviolet light interact with a material's weathering reciprocity characteristics.

Problems associated with the prior art attempts to characterize a weathering reciprocity of a material are well described in the paper by A. L. Andrady, et al. entitled “Effects of Increased Solar UV Radiation on Materials,” JOURNAL OF PHOTOCHEMISTRY AND PHOTOBIOLOGY: BIOLOGY 46 (1998) 96-103, and the references cited there within. In particular, the prior art did not account for the dynamic nature of material in-service conditions. Materials in end-use outdoors encounter oscillations in intensity of light and temperature such as daily, morning-noon-afternoon temperature/light intensity oscillations, hourly intensity oscillations due to clouds and breezes, seasonal oscillations to summer and winter and yearly oscillations due to solar changes in atmospheric phenomenon. These types of intensity oscillations are not simulated in prior artificial light source laboratory style characterizations of light/time weathering degradations.

Further, addition and subtraction of reflective elements actually present a very significant barrier to reciprocity characterization. Simply adding or subtracting reflective elements alone will not allow accurate characterization of a material's intensity/time degradation response. This is because changing the number of mirrors also effects the material exposure temperature. Exposure temperature is another independent variable that can significantly affect weathering degradation rate. Prior art attempts to characterize weathering reciprocity of a material fail to account for interactions, synergy or antagonism, between multiple variables while studying the dose relationships.

The concept of theoretical reciprocity can be developed farther into intensity/time relationship. Those of skill in the art will recognize that unrealistic light intensities, used for very short exposure durations, or unrealistic exposure durations, used at very low intensities, involve interactions that make realistic weathering degradation characteristics dose-time relationships less likely. Further, the intensity/time characteristics must be individually defined for each material by characterizing and understanding a material's intensity/time weathering characteristics. As a result of the present invention, an operator may intelligently pick variables and intensities to greatly accelerate a material weathering degradation rate while, at the same time, maintain realistic weathering degradation characteristics, i.e., those material characteristics actually observed in the real-time outdoor weathering.

Therefore, there exists a need in the art for a method and apparatus to empirically determine or characterize the sunlight intensity/duration relationship or a reciprocity of a material that overcomes the problems inherent in the prior art approaches, including, but not limited to, cost, unnatural light sources, confounding of variables, insufficient control of variables, etc. so that a correlation factor for such material may be available in further testing or use.

### DESCRIPTION OF THE DRAWINGS

The invention may be best understood by reference to the following description taken in conjunction with the accompanying drawings, in these several figures of which like reference numerals identify like elements.

FIG. 1 is a perspective view of a natural or outdoor accelerated weathering test apparatus in accordance with one embodiment of the present invention.

FIG. 2 is a perspective cut-away view of one embodiment of an apparatus for adjusting a temperature of test specimens for use with the natural accelerated weathering test apparatus of FIG. 1.

FIG. 3 is a perspective view of another natural accelerated weathering test apparatus in accordance with one embodiment of the present invention.

FIG. 4 is a schematic view of an array of natural accelerated weathering test apparatus configured for regulating temperature variability between the various natural accelerated weathering test apparatus in accordance with one embodiment of the present invention.

FIG. 5 is a schematic representation of one embodiment of the present invention illustrating the array shown in FIG. 6 illustrating one embodiment for exposing test specimens to different light intensities applied by each accelerated weathering test apparatus.

FIG. 6 is a graphical representation of various observed accelerated weathering degradation rates of a preselected material on a set of natural accelerated weathering test apparatus.

FIG. 7 is a graphical representation of theoretical and observed weathering reciprocity correction factors.

FIG. 8 is a schematic representation of one embodiment of the present invention illustrating an array of natural accelerated weathering test apparatus including a plurality of sets thereof and a plurality of groups thereof.

FIG. 9 is a schematic representation of one embodiment of the present invention illustrating characteristics of various cut-off filters that may be used in accordance with one embodiment of the present invention.

FIG. 10 is a schematic representation of one embodiment of the present invention illustrating a plurality of arrays of natural accelerated weathering test apparatus where each array includes a plurality of sets of natural accelerated weathering test apparatus and a plurality of groups of natural accelerated weathering test apparatus and wherein each natural accelerated weathering test apparatus in each array includes a spectral cut-off filter.

FIG. 11 is a graphical representation of one embodiment of the present invention illustrating a weathering reciprocity correlation factor for a preselected material.

### DETAILED DESCRIPTION OF A PREFERRED EMBODIMENT OF THE INVENTION

Briefly, in one embodiment, an assembly for characterizing weathering reciprocity of a material includes an array of natural accelerated weathering test apparatus of the type used to concentrate solar radiation upon test specimens formed from the material. Each natural accelerated weathering test apparatus includes a temperature control system for maintaining the test specimens at a desired temperature. A plurality of sets of natural accelerated weathering test apparatus are defined within the array. The test specimens in each set are exposed to a different solar radiation intensity.

In another embodiment, the assembly for characterizing weathering reciprocity of a material includes an array of natural accelerated weathering test apparatus of the type used to concentrate solar radiation upon test specimens formed from the material. Each natural accelerated weathering test apparatus includes a temperature control system for maintaining the test specimens in the array at a desired temperature. A plurality of sets of natural accelerated weathering test apparatus are defined within the array. The test specimens in each set are exposed to a different solar radiation intensity. A plurality of groups of natural accelerated weathering test apparatus are also defined within the array. The test specimens in each group are maintained at a temperature offset relative to the desired temperature.

In yet another embodiment, the assembly for characterizing weathering reciprocity of a material includes a plurality of arrays of natural accelerated weathering test apparatus of the type used to concentrate solar radiation upon test specimens formed from the material. Each natural accelerated weathering test apparatus includes a temperature control system for maintaining the test specimens at a desired temperature. A plurality of sets of natural accelerated test apparatus are defined within each array. The test specimens in each set are exposed to a different solar radiation intensity. A plurality of groups of natural accelerated weathering test apparatus are also defined within each array. The test specimens in each group are maintained at a temperature offset relative to the desired temperature. The test specimens of each array are exposed to a different solar radiation wavelength range.

In still another embodiment of the present invention, a method for characterizing weathering reciprocity of a material includes configuring a plurality of natural accelerated weathering test apparatus of the type used to concentrate solar radiation upon test specimens formed from the material in an array. A temperature control system is connected to each natural accelerated weathering test apparatus disposed in the array. A plurality of sets of natural accelerated weathering test apparatus are defined within the array. The test specimens in the array are maintained at a desired temperature and the test specimens in each set are exposed to a different solar radiation intensity.

In still yet another embodiment of the present invention, the method for characterizing weathering reciprocity of a material includes configuring a plurality of natural accelerated weathering test apparatus of the type used to concentrate solar radiation upon test specimens formed from the material in an array. A temperature control system is connected to each natural accelerated weathering test apparatus disposed in the array. A plurality of sets of natural accelerated weathering test apparatus are defined within the array. A plurality of groups of natural accelerated weathering test apparatus are also defined within the array. A desired temperature for the test specimens is determined. The test specimens in each set are exposed to a different solar radiation intensity. The test specimens in each group are maintained at a temperature offset to the desired temperature.

In a further embodiment of the present invention, the method for characterizing weathering reciprocity of a material includes configuring a plurality of natural accelerated weathering test apparatus of the type used to concentrate solar radiation upon test specimens formed from the material in a plurality of arrays. A temperature control system is connected to each natural accelerated weathering test apparatus disposed in each array. A plurality of sets of natural accelerated weathering test apparatus are defined within each array. A plurality of groups of natural accelerated weathering test apparatus are also defined within each array. A desired temperature is determined for the test specimens. The test specimens in each set are exposed to a different solar radiation intensity. The test specimens in each group are maintained at a temperature offset to the desired temperature. The test specimens in each array are exposed to a different desired solar radiation wavelength range.

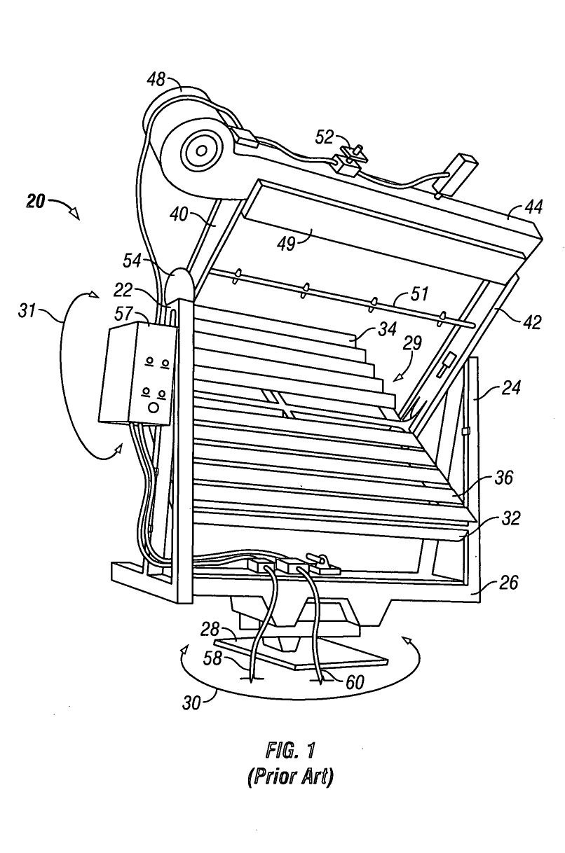

Referring to FIG. 1, a natural accelerated weathering test apparatus is designated generally by reference 20 and is described in detail in U.S. Pat. No. ______, application Ser. No. 10/151,577, in particular at Paragraphs [0024] to [0041]; however, all disclosure of such patent is hereby incorporated by reference as if fully set forth herein. In one embodiment of the present invention, the natural accelerated weathering test apparatus 20 includes a pair of A-frame members 22 and 24 to support the operative portion of the apparatus. The lower ends of the A-frame members 22, 24 are interconnected by a base member 26, which is operatively connected to a ground member 28 in order to provide azimuth rotation in the direction indicated by arrow 30 and elevation rotation in the direction indicated by arrow 31. The elevation direction rotation accounts for periodic variation in the sun's altitude throughout the day (diurnal) and year (seasonal).

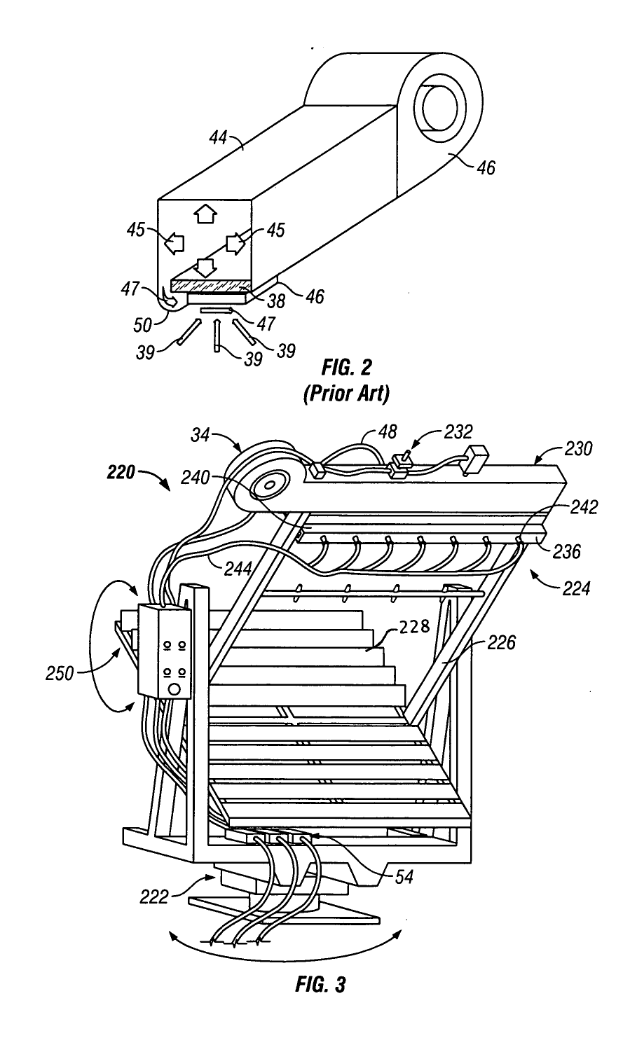

A concentrating device 29 is rotatively supported from the upper ends of A-frame members 22, 24. The concentrating device 29 shown in this embodiment includes a mirror bed frame 32, which supports a plurality of flat mirrors, including those designated by reference numerals 34 and 36. The plurality of mirrors 34, 36 are angled to reflect solar radiation directly impinging upon such mirrors to a target board 38 (see FIG. 2).

A pair of standards 40 and 42 extend outwardly from and perpendicular to mirror bed frame 32. An air tunnel 44, having a generally rectangular cross-section, is supported by the upper ends of standards 40, 42. Referring to FIG. 2, target board 38 is supported by the lower wall of air tunnel 44, and a plurality of test specimens 46 are mounted to the target board 38 for exposure to the concentrated solar radiation, represented in FIG. 2 by the upwardly extending arrows numbered 39. An apparatus for adjusting a temperature of the test specimens 46 may be embodied in one form as a squirrel cage blower assembly 48, which communicates with one end of the air tunnel 44. Squirrel cage blower assembly 48 includes a fan driven by an electric motor to circulate cooling ambient air through air tunnel 44, represented in FIG. 2 by the outwardly extending arrows numbered 45. As shown in FIG. 2, air tunnel 44 includes a deflector 50, which extends for the length of target board 38 and causes cooling ambient air to be circulated across target board 38 for cooling test specimens 46, represented in FIG. 2 by the arrows numbered 47.

Standards 40, 42 are rotatively supported by upper ends of A-frame members 22, 24. A supporting shaft, coincident with the axis of rotation passing through standards 40, 42, rotably supports that portion of the test apparatus that tracks daily movements of the sun. In order to properly position the concentrating device 29, a reversible electric motor and related gear drive, generally designated by reference number 54, are provided for periodically rotating the concentrating device 29 mirror bed and target board assembly to track movements of the sun. A clutch preferably couples standard 40 to a shaft to rotate the mirror assembly 34, 36 and target board assembly while permitting manual positioning of the unit at any time to correct for any positioning errors.

A solar cell tracking unit 52 controls the application of electrical power to a reversible motor in order to maintain the mirror bed frame 32 perpendicular to incident rays of sunlight. A solar tracker may be of the type that includes two balanced photo cells and a shadowing device mounted above such photo cells for shading them. When an imbalance, resulting from one photo cell receiving more sunlight than the other photo cell, is detected, an electrical error signal is generated, which is amplified and used to apply power to the drive motor 54 for rotating the unit until the photo cells are again balanced, indicating that the unit is properly positioned with respect to the sun.

Also shown in FIG. 1 is a water spray nozzle assembly, designated generally by reference numeral 51. As shown in FIG. 1, spray nozzle assembly 51 is used to periodically spray water at the test specimens to simulate dew, rain, etc.

A hinged shield or cover 49 is shown coupled to the air tunnel 44 opposite the air deflector 50 (see FIG. 2). A door latch mechanism is disposed on the air tunnel 44 for engaging and maintaining the shield in an open position as shown in FIG. 1. Upon release, the shield 49 assumes a closed position to protect the test specimens 46 from concentrated solar radiation reflected by the plurality of mirrors 34, 36.

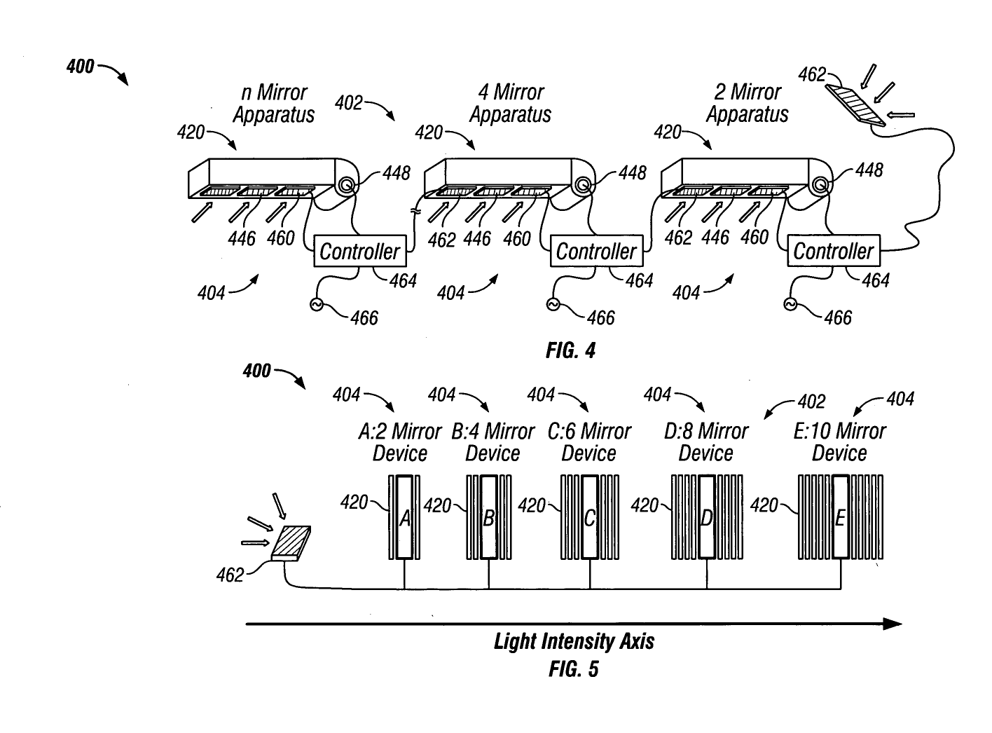

Referring now to FIG. 2, the target board 38 is shown, including at least one test specimen 46 secured thereto. While only one test specimen is shown, a plurality are preferably used. Also secured to the target board 38 is a feedback device 460 (see FIG. 4) having at least one temperature-sensitive component operatively associated in heat conductive relationship therewith. Such component may be a thermister, thermocouple, resistance temperature device, integrated circuit temperature device or any other suitable device for detecting temperature of the feedback device 460. The feedback device 460 may be formed from a standardized material having known solar absorption and thermal conductive properties, may be formed from a material similar to that of the test specimen or the test specimen. The temperature-sensitive component may be embedded within, connected to a back surface or connected to a front surface of the feedback device. Alternatively, a non-contact optical temperature sensing device may be used in order to determine the temperature of the feedback device or the test material. The feedback device 460 is preferably coated with black paint to insure that the feedback device 460 will absorb solar radiation impinging upon the area of the target board 38 to which the feedback device 460 is secured. An appropriate black paint that may be used for this purpose is DUPONT DULUX Super Black High Temperature Enamel or any other suitable point.

Referring again to FIG. 1, a controller box 57 houses the power and controller systems for the apparatus 20. A power cable 58 supplies electrical power to the apparatus 20 for powering the electric motor 34, which actuates the fan 48 (see FIG. 3). A signal cable 60 is connected to the controller system disposed within the control box 57 for communication with remotely disposed devices such as the feedback devices and input device, as will be discussed below, or for communication with a central command for governing the operation of the apparatus 20 in accordance with the present invention.

Referring to FIG. 3, a perspective view of an outdoor natural accelerated weathering test apparatus in accordance with an embodiment of the present invention, designated generally by reference numeral 220 as is described in detail in U.S. Pat. No. ______, application Ser. No. 10/295,098, in particular at Paragraphs [0028] to [0079]; however, all of such patent is hereby incorporated by reference as if fully set forth herein. The accelerated weathering test apparatus 220 concentrates solar radiation upon a plurality of test specimens and exposes such tests specimens to a fluid from a fluid source during a test cycle. It will be recognized by those of skill in the art that the fluid may take the form of a liquid, gas or combination of liquid and gas. The basic accelerated weathering apparatus 220 includes a support member 222 connected to an operative portion 224. The operative portion 224 includes a frame 226, which supports a concentrating device 228 disposed in opposition to an air tunnel 230.

The concentrating device 228 of this embodiment of the invention is configured as a fresnel-reflecting apparatus having a series of ten flat mirrors, which focuses natural sunlight onto a series of test specimens secured to a target board 38 (as best shown in FIG. 2 by way of example) secured to the air tunnel 230 and which measures approximately six (6) inches wide by fifty (50) inches long. The concentrating device 228 directs solar radiation onto the target board area with an intensity of approximately eight suns.

Both the mirror bed of the concentrating device 228 and the target board are supported by a frame 226, which can be rotated to follow daily movements of the sun. A solar tracking mechanism 232, responsive to the position of the sun, controls the operation of an electric motor used to rotate the test apparatus to follow movements of the sun. The solar tracking mechanism 232 may be any conventionally available apparatus that provides such function.

The support member 222 may be formed as a dual-axis tracking apparatus, as shown in FIG. 3, or as a single-axis tracking apparatus, as shown in U.S. Pat. No. 4,807,247. Both tracking apparatus may use any conventional solar tracking unit 232, which controls the orientation and position of the support member 222 and operative portion 224 in order to maintain the mirror bed 228 perpendicular to incident rays of sunlight. Both of these support members are well-known in the art and described in ASTM Standard G90-94. It is within the teachings of the present invention that other suitable support members could be utilized for providing adjustment of the apparatus relative to the sun.

The frame 226 extends upwardly and perpendicular to the mirror bed 228. The air tunnel 230 has a generally rectangular cross-section and is supported by the upper ends of the frame 226. An apparatus for adjusting the temperature of the test specimens is configured in this embodiment as an air circulation mechanism 34, preferably in the form of a squirrel cage blower assembly, which is in communication with one end of the tunnel 230. It will be recognized that any apparatus suitable for moving air may be substituted for the squirrel cage blower. The squirrel cage blower assembly preferably includes a fan driven by an electric motor to circulate cooling ambient air through the tunnel 230. It is within the teachings of the present invention that any conventional control system may be associated with the air circulation mechanism 34. For example, the control system may include temperature-sensing panels associated with sensors to determine the temperature of the test specimens on the target board in order to selectively control the application of electrical power to the electrical motor within the squirrel cage blower assembly or any other suitable control system, as described in more detail herein.

The air tunnel 230 includes a deflector that extends for the length of the target board, as discussed below, and serves a different function in the present invention, acting primarily as a vent to direct cooling air from the air tunnel.

In this embodiment of the present invention, a channel 236 is connected to the target board and includes a cover to define a chamber. A fluid source (as described in detail below) is in communication with the chamber whereby fluid is introduced into the chamber in order to react with a specimen to accelerate degradation of the specimen during and between periods of exposure to concentrated solar radiation. The channel 236 includes a base and a pair of oppositely disposed, elongated sidewalls 240 extending from the base. At least one first port 242 is disposed in one of the sidewalls 240. A first conduit 244 operatively connects each first port 242 to the fluid source such that the first conduit in each first port defines a first passageway for the fluid from the fluid source to the chamber.

A control apparatus 250 is preferably available and programmable to control, among other things related to the general operation of the accelerated weathering apparatus 220 (e.g., solar tracking and minor bed adjustments, fluid flow, etc.), at least one regulator operatively connected to the first passageway, the fluid source for controlling the supply of the fluid from the fluid source to the chamber and at least one second regulator operatively connected to a second passageway for controlling the desired rate of removing the fluid from the chamber. Each of the at least one first and second regulators is responsive to the control apparatus 250 such that a signal from the control apparatus 250 actuates the regulator from a first normally closed position to a second open position for a desired period of time so that fluid may be supplied to or removed from the chamber during a test cycle. It is within the teachings of this invention that each of the at least one first and second regulators may be opened from the first normally closed position to a second open position, which is some desired percentage of the full open position.

It will be recognized that the control apparatus 250 is preferably of an electrical/electronic design that is programmable to provide the above functions and that a mechanical design can be utilized to provide identical functionality. For example, while a digital solid state apparatus is preferred for simplicity, programmability, reliability and cost, it will be recognized that an analog apparatus, such as a timer-based system, will provide the same function. Further, it is also within the teachings of this invention that activation of the regulators can also be performed manually by an operator.

In the present invention, the channel 236 is connected to the target board and the test specimens are mounted therein. A gap is defined between the target board and an open side of the air tunnel 230 to provide a discharge for cooling air generated by the apparatus for adjusting temperature, as will be discussed in detail below. Preferably, the channel 236 is connected to the target board by means of a threaded fastener. However, it will be recognized by those of skill in the art that any suitable fastener apparatus, material or device may be used.

The channel 236 includes a base and a pair of oppositely disposed elongated sidewalls 240 extending from the base. Each sidewall 240 has an elongated receptacle formed therein for receiving an edge of the cover. A gasket is disposed between the cover and the receptacle to seal the channel 236 (as will be discussed in detail below). A chamber is defined when the cover is operatively connected to the channel 236 such that the cover edges are received within the opposed elongated receptacles.

At least one first port 242 is disposed in one of the side walls 240 for operative connection with the first conduit in order to define the first passageway for the fluid from the fluid source to the chamber. It is within the teachings of the present invention that each at least one first port 242 may also be disposed in either end wall. Each first port 242 is preferably configured as a threaded barb fitting for ease of assembly and interchangeability with a complementary threaded bore defined in one of the side walls 240. It will be recognized by those of skill in the art that ports having different configurations and other suitable apparatus may be substituted therefor. For example, taper fittings, threaded pipe fittings, compression fittings, push-lock fittings or any other suitable apparatus may be used. Moreover, the first ports 242 may be integrally formed as part of the side wall 240.

In one embodiment of the present invention, at least one second port is disposed in one of the side walls 240 and is operatively connected to the second conduit to define the second passageway for removing the fluid from the chamber at a desired rate. Preferably, each at least one second port is disposed in opposition to the wall connected to the first ports 242, whether that is a side wall 240 or an end wall. It is within the teachings of the present invention that each second port may be configured the same as taught for each first port 242 above.

The cover is light transmittant and preferably includes a filter element. It is within the teachings of the present invention that the cover and filter element may be integrally or independently formed. In one embodiment, the cover may be transparent and the filter element may be formed from borosilicate or any other UV transparent coating. It will be recognized by those of skill in the art that other constructions and configurations for the cover and filter element will provide suitable function. For example, the cover may also be translucent, formed of glass, or any other suitable material. The filter element may be formed from quartz, transparent substrate, translucent substrate, automobile window glass, architectural window glass, evaporated thin film optical coatings, interference filters, quarter-wave filters, specific wavelength-filtering elements, or any other suitable construction or configuration.

At least one regulator is operatively connected to the first passageway for controlling the desired rate and amount of fluid introduced into the chamber 236. At least one regulator is operatively connected to the second passageway for controlling the desired rate of removing the fluid from the chamber 236. The fluid removed from the chamber 236 preferably analyzed for degradation products from the specimen 46 (see FIG. 2). The analysis technique for identifying the degradation products from the specimen 46 (see FIG. 2) may be any conventionally available process. For example, Fourier-transform infrared spectroscopy, gas chromatography, high-pressure liquid chromatography or any other suitable process may be used.

A fluid source, in accordance with one embodiment of the present invention, may include a tank containing the fluid and a regulator for controlling flow of the fluid from the tank to the chamber via the first passageway. The fluid may be any suitable composition for enhancing degradation of the specimen. For example, the fluid may be water, oxygen, nitrogen, organic or inorganic solvents, acids, bases, salts, dissolved salts, oxides of sulfur, oxides of nitrogen, oxides of hydrogen, peroxides, ozone, or any other suitable fluid or mixture. Preferably, in this embodiment, the fluid is a gas mixture under pressure such that opening the regulator enables flow of the fluid to the chamber. The gas may be any gas suitable for enhancing degradation of the specimen. For example, the gas may be oxygen, nitrogen, oxides of sulfur, oxides of nitrogen, oxides of hydrogen, ozone, or any other suitable gas or mixture.

Another embodiment of the fluid source, in accordance with the present invention, includes a plurality of tanks, each holding a different fluid and each operatively connected to a manifold for communication via the first passageway with the chamber. A regulator operatively connects each tank to the manifold and at least one regulator is electrically actuated by the control system. The fluid disposed in each of the tanks may be any suitable fluid for enhancing degradation of the specimen as discussed above. It is within the teachings of the present invention that one, more than one or all of the regulators may be actuated manually, mechanically, or in any other suitable manner.

Yet another embodiment of the fluid source in accordance with the present invention includes a tank containing fluid and a regulator for controlling flow of the fluid from the tank to the chamber via the first passageway. In this embodiment, the fluid is preferably a liquid, which may be any liquid suitable for enhancing degradation of the specimen. For example, the liquid may be water, organic and/or inorganic solvents, acids, bases, salts, dissolved salts, peroxides, or any other suitable liquid or mixture. In this embodiment, the control system electrically actuates the regulator to control flow of the fluid from the tank to the chamber. A pump may be operatively connected to the first passageway in order to enable the fluid to flow from the tank to the chamber. Other methods, such as gravity feed, may also be used to provide identical functionality.

Still another embodiment of the fluid source, in accordance with the present invention, includes an accumulator in communication with a first tank, a second tank and the chamber via the first passageway. The first tank contains a gas under pressure and has a regulator for controlling flow of the gas from the first tank to the accumulator. The second tank contains a liquid. It has a regulator for controlling flow of the liquid from the second tank to the accumulator.

The liquid is drawn from the second tank through the regulator by pump that pumps the liquid through a conduit into the accumulator. A nozzle is disposed at the distal end of the conduit in order to atomize and spray the liquid into the accumulator. The gas in the first tank is pressurized such that when the regulator is opened, the gas flows through conduit and pressurizes the accumulator. The pressure in the accumulator is observable by a pressure gauge.

The accumulator is pressurized such that the gas diffuses into the liquid as it is sprayed into the accumulator. A pump draws the gas/liquid combination from the accumulator and directs such combination to the chamber via the first passageway. In this embodiment, the gas may be any gas suitable for accelerating degradation of the test specimen. For example, the gas may be oxygen, nitrogen, oxides of sulfur, oxides of nitrogen, oxides of hydrogen, ozone, or any other suitable gas or mixture. Further, the liquid may be any liquid suitable for accelerating degradation of the test specimens. For example, the liquid may be water, organic solvents, inorganic solvents, acids, bases, salts, dissolved salts, peroxide or any other suitable liquid or mixture. The control system electrically actuates at least one of the regulators. As shown in this embodiment, the liquid regulator is electrically actuated by the control system and the gas regulator is manually controlled. It will be recognized that the control system may electrically actuate both regulators if so desired in order to achieve the intended function.

Another embodiment of the apparatus for adjusting the temperature of the test specimens for the present invention includes the apparatus disposed contiguous with one side of the test specimens to maintain the test specimens at a desired temperature. The apparatus includes a base contiguous with the specimen and at least one fin that extends from the base through the base of the channel and the opening of the target board into the air tunnel. The at least one fin transfers and dissipates heat from the test specimens to the air moving through the air tunnel by the fan. The air is then discharged through the gap past the air deflector. In this embodiment, the apparatus is preferably a metallic heat sink. It will be recognized that the apparatus may also be structurally configured from any other material having suitable heat transfer properties. For example, the apparatus may be constructed of any non-insulative material capable of conducting heat.

Yet another embodiment of the apparatus for adjusting the temperature of the test specimens in accordance with the present invention includes the apparatus configured differently to provide the same function. In this embodiment, the apparatus includes a base contiguous with the test specimens. At least two spaced legs extend from the base into the air tunnel in order to dissipate heat from the test specimens to the air moving through the air tunnel. A top is connected to the legs and has a first end and a second end to which a voltage source is applied. Preferably, the apparatus is a thermoelectric apparatus having legs constructed of semiconductor material such that the voltage differential between the first end and second end results in dissipation of heat from the specimen to the air moving through the air tunnel.

It will be recognized that the thermoelectric apparatus is a solid state heat pump that operates on the Peltier effect, the theory being that there is a heating or cooling effect when electric current passes through two conductors. A voltage applied to the free ends of two dissimilar materials creates a temperature difference. With this temperature difference, Peltier cooling will cause heat to move from one end to the other.

In this embodiment, the thermoelectric apparatus consists of an array of p- and n-type semiconductor elements that act as two dissimilar conductors. Namely, one leg is a p-type while the other leg is an n-type semi-conductor element. In the event other legs are used, as described, the array repeats in succession: p-type, n-type, p-type, n-type, etc. The array of elements is soldered between two ceramic plates, electrically in series and thermally in parallel. As a DC current passes through one or more pairs of elements from n-type to p-type, there is a decrease in temperature at the base (cold side), resulting in the absorption of heat from the test specimen. The heat is carried through the thermal electric apparatus by electron transport and released on the top (hot side) as the electrons move from a high to low energy state. The heat pumping capacity of a thermoelectric apparatus is proportional to the current and the number of pairs of n-type and p-type elements (or couples) in the apparatus. The air circulation mechanism moves air through the legs of the thermoelectric apparatus whereby heat is transferred from the top to the air, which is then discharged through the gap and past the air deflector.

Still another embodiment of the apparatus for adjusting a temperature of the test specimens of the present invention includes test specimens disposed within the chamber to define a cavity such that a first side of the test specimens is exposed to the chamber and a second side of the test specimens is exposed to the cavity. An apparatus is disposed within the cavity contiguous with the specimen to maintain the specimen at a desired temperature.

In this embodiment, the apparatus is configured as a flexible walled vessel for receiving a coolant to maintain the specimen at a desired temperature. The flexible walled vessel is disposed in a first operative position wherein there is no coolant disposed within the flexible walled vessel. In a second operative position, the flexible walled vessel has coolant disposed therein and therefore expands to conform to the specimen and cavity walls.

The flexible walled vessel is operatively connected to an inlet, which is in communication with a coolant source, and an outlet, which is regulated to remove the coolant from the flexible walled vessel at a desired rate. The coolant and flexible walled vessel, in this embodiment, may be constructed of any non-insulative material suitable for absorbing heat from the specimen. For example, the coolant may be refrigerated air, ethylene glycol, fluorocarbon refrigerants, alcohol, refrigerant gases, fluids used for heat exchange or any other suitable material. The flexible walled vessel may be constructed of any natural or engineered elastomeric material, such as rubber, or any other suitable material. However, the air circulation mechanism is not required for this embodiment to properly function.

Referring to FIGS. 4 and 5, in one embodiment of the present invention, an assembly 400 is schematically illustrated for tightly regulating temperature variability amongst an array comprised of a plurality of natural accelerated weathering test apparatus 420 of the type used to concentrate solar radiation upon at least one test specimen 446 on each natural accelerated weathering test apparatus 420 during an exposure test. It will be recognized by those of skill in the art that the natural accelerated weathering apparatus 420 in each of FIGS. 4 and 5 is directed to the same embodiment of the present invention, illustrating different views thereof. The at least one test specimen 446 disposed on each of the plurality of apparatus is preferably the same. However, a plurality of different test specimens may be used in one exposure test with this system in order to determine the weathering reciprocity of many materials in one exposure test. Thereby, each of the different test specimens is tested under the exact same conditions and all are accordingly tightly regulated.

The assembly 400 for characterizing weathering reciprocity of a material, in the form of a test specimen 446, includes an array 402 of natural accelerated weathering test apparatus 420. In this embodiment of the present invention, the array 402 includes, by way of example only, five (5) natural accelerated weathering test apparatus, each with a concentrating device for directing concentrated solar radiation intensity onto test specimens. The array 402 further includes a plurality of sets 404 of apparatus 420 defined within the array 402. In this embodiment, each natural accelerated weathering test apparatus 420 represents a set 404. FIG. 4 illustrates at least three (3) sets and up to “n” sets within the array 402. FIG. 5 illustrates five (5) sets defined within the array 402. The test specimens 446 in each set are exposed to a different solar radiation intensity.

In operation, a method for characterizing weathering reciprocity of a material includes the following steps: configuring a plurality of natural accelerated weathering test apparatus of the type used to concentrate solar radiation upon test specimens formed from the material in an array; connecting a temperature control system to each natural accelerated weathering test apparatus disposed in the array; defining a plurality of sets of natural accelerated weathering test apparatus within the array; maintaining the test specimens at a desired temperature; and exposing the test specimens in each set to a different solar radiation intensity. Each natural accelerated weathering test apparatus 420 includes a temperature control system 404, as described above and below in more detail, for maintaining the test specimens 446 at a desired temperature.

Each of the plurality of sets 404 includes at least one natural accelerated weathering test apparatus 420, which includes a concentrating device having at least one concentrating element. In another embodiment, each concentrating device includes a number of concentrating elements CE such that the number of concentrating elements CE is directly proportional to a number of each sets whereby the number of concentrating elements is determined from the equation: CE=S.

In yet another embodiment, each concentrating device includes a number of concentrating elements CE such that the number of concentrating elements CE is proportional to a number of each set S, whereby the number of concentrating elements is determined from the equation: CE=S*2. This embodiment is clearly illustrated in FIG. 5 wherein a first set includes two concentrating elements, a second set includes four concentrating elements, a third set includes six concentrating elements, a fourth set includes eight concentrating elements and a fifth set includes ten concentrating elements.

In still another embodiment, each concentrating element may be adjusted with respect to the test specimens in order to provide the different solar radiation intensity. Such embodiment may be enabled where each concentrating device having a focal length that may be adjusted with respect to the test specimens in order to provide the different solar radiation intensity.

Each apparatus 420 is adapted to dynamically control a test specimen temperature to simulate complex temperature cycles of a material end-use application. The system includes a plurality of accelerated weathering test apparatus 420, as generally described above, including a controller 464, a feedback device 460 and an input device 462. Each of the apparatus 420 operates to dynamically control a test specimen temperature of test specimens mounted thereon to simulate complex temperature cycles of a material end-use application. The feedback device 460 is mounted to the target board for exposure to the concentrated solar radiation and generating a test signal responsive to the temperature thereof and representative of the test specimen temperature. The input device 462 generates a dynamic reference signal representative of a complex temperature cycle of a materials end-use application. The controller 464 is connected to the input device 462 and feedback device 460.

The controller 464 is also responsive to the reference signal for generating a dynamic temperature set point. The controller 464 is also responsive to the feedback signal for selectively controlling application of electric power 466 to the electric motor 448 in order to control a rate at which ambient air is circulated over the target board. The rate is generally increased when the temperature of the feedback device 460 is greater than the dynamic temperature set point and is generally decreased when the temperature of the feedback device 460 is less than the dynamic temperature set point. The rate is generally maintained constant when the temperature of the feedback device 460 is substantially equal to the dynamic temperature set point.

In one embodiment of the present invention, controller 464 includes a temperature controller of the type commercially available from Eurotherm, West Sussex, United Kingdom, as model number 2408, connected to an adjustable alternating current motor speed control of the type commercially available from Boston Fincor of York, Pa., as model number ACX. The aforementioned motor speed control is a solid state, single phase, variable motor speed controller that provides control in proportion to the error sensed between a dynamically adjustable set point, determined from the reference signal, as discussed below, and the temperature actually sensed by feedback device 460. The controller 464 includes at least three inputs, a test signal, a reference signal and a power signal. The output of the controller 464 is coupled to one side of the blower motor 448. The opposite of the blower motor 448 is coupled to ground. In one embodiment of the present invention, blower motor 448 is a Grainger Model Number 3805 and the temperature sensing device is preferably a type-T thermocouple, attached to a test specimen or a standardized black panel.

Other suitable controllers may be used; for example, a processing module including a processor and memory to facilitate management of the operations of the processing module. The processor may be a microprocessor, central processing unit or micro-controller, application-specific integrated circuit, field programmable gateway, a digital signal processor, a micro-controller or any other suitable processing device. If the processor is a microprocessor, it can be a “PENTIUM,” “POWER PC,” or any other suitable microprocessor, CPU or micro-controller commonly known in the art. The memory may be read-only memory, random access memory, rewritable disc memory, write-once-read-many disc memory, electrically erasable programmable ROM (EEPROM), holographic memory, remote storage memory or any other suitable memory device commonly known in the art. The memory includes instructions that are executed by the processor as well as programming variables or any other suitable programming source code or object code commonly known in the art.

As discussed above, controller 464 is responsive to a reference signal from an input device 462 for generating a dynamic or static temperature set point. The reference signal may be generated by various different type input devices, each of which detects a complex temperature cycle of a material in end-use condition. For example, an input device may be configured as a standardized material or a material being tested, each having a temperature-sensitive component disposed as would be used in such an end-use application as an input device, such as on a roof or other similar structure, on the interior or exterior of an automobile or other similar structure, or on the interior or exterior walls or roof of a building or other similar structure.

An end-use application environment temperature cycle may be recorded by any conventional manner and replayed such that the natural accelerated weathering test apparatus may reproduce the dynamic reference signal of such recorded environment. An apparatus such as a computer may be used for generating a complex temperature cycle, as specified by a user to generate the desired reference signal. The computer may also be used for generating a modified version of a recorded end-use application environment temperature cycle to provide environmental temperature elements not commonly observed. A non-contact monitoring device, such as an optical infrared pyrometer may be used to generate the reference signal and, alternatively, the test signal.

The advantage of compatibility with such a wide variety of input devices is that the accelerated weathering test apparatus may be permanently installed in a preferred location, such as, for example, Florida or Arizona, and end-use application environment temperature cycles from any other location may be repeatedly and reproducibly simulated in an exposure test. For example, the input device may be installed on the interior or exterior of an automobile and the automobile may be either parked at a single location for a specified period of time or moved about within a certain region for a specified period of time. The reference signal may then be recorded, modified or transmitted in real time to the controller in order to generate the dynamic reference signal and corresponding dynamic temperature set point on a periodic basis. In another example, an environment temperature cycle in the Amazon Rain Forest or other critical end-use locations, such as Death Valley, for example, may be recorded, so that it may be repeatedly and reproducibly simulated at the testing location.

However, in this embodiment, the plurality of test apparatus 420 are collectively used in one exposure test. A disadvantage of the prior art when attempting an exposure test of this scale, is that, the test specimen temperature variance from apparatus to apparatus can be quite large. As a result, any results of the exposure test have a sizable standard deviation. In order to more tightly regulate such standard deviation from apparatus to apparatus, this embodiment of the present invention has the input device 462 of a first one apparatus disposed remote from a plurality of accelerated weathering test apparatus 420. The input device 462 of each other apparatus is consecutively linked in series to the first one apparatus such that the other apparatus are dependently controlled therefrom and temperature variably across the system is reduced. This type of arrangement is commonly referred to in the computer networking field as a “daisy chain,” which is defined in Merriam-Webster's Collegiate Dictionary as an interlinked series, much like the links of a chain. This structural configuration, where a second apparatus operates in response to its remote device disposed on a first apparatus, reduces the standard deviation and thereby increases the repeatability or reproducibility of the test results. It will be recognized by those of skill in the art that other structural and functional configurations may also be used. For example, each set may be linked directly to the input device or a known “bus bar” configuration may be used.

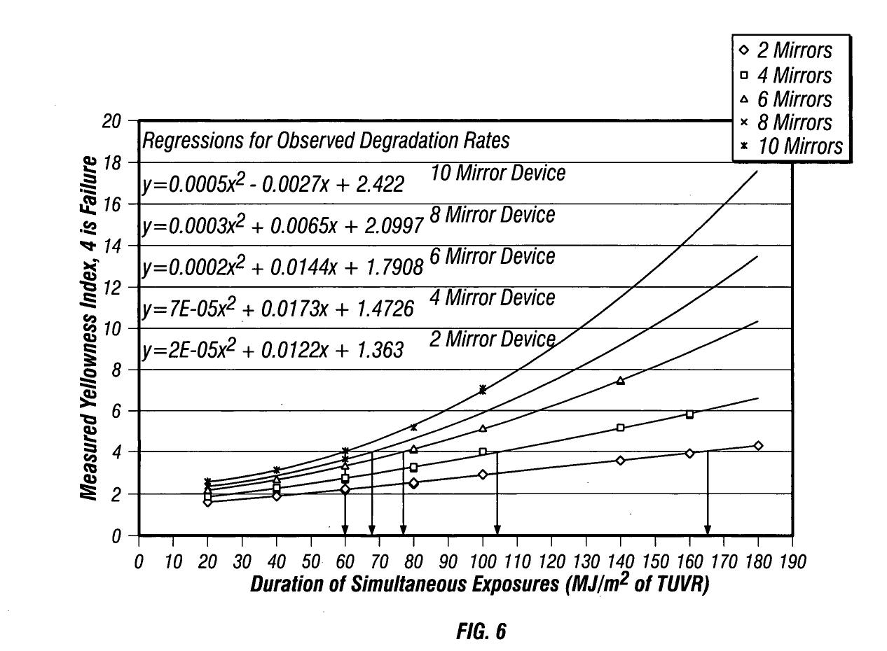

FIG. 6 is a graphical representation of various observed accelerated weathering degradation rates of a preselected material on a natural accelerated weathering test apparatus configured in accordance with one embodiment of the present invention as set forth above. It will be recognized by those of ordinary skill in the art that the preselected material may be any desired material. For example, in this embodiment, the degradation characteristic, i.e. yellowing, of polystyrene was measured at regular intervals during the exposure periods. The degradation data is plotted, as shown in FIG. 6. and regression lines were fitted for each of the five (5) different light intensities. It will be recognized that any suitable structural configuration for facilitating different light intensities may be used. A failure, or point of degradation beyond which the yellowing was unacceptable, was defined as a change or delta of four (4) yellowness index units from the original. The duration of the exposure required to degrade the polystyrene to the failure point was noted for each of the five (5) solar intensities. In this embodiment, a concentrating device having a fresnel-type reflector with a plurality of mirrors was used. However, any other suitable concentrating device may be used. For a ten (10) mirror natural accelerated weathering test apparatus, approximately sixty (60) mega joules per square meter of total ultra violet radiation (MJ/m² TUVR) were required for failure, whereas approximately sixty-eight (68) MJ/m² TUVR were required for failure on the eight (8) mirror natural accelerated weathering test apparatus, approximately seventy-eight (78) MJ/m² TUVR for failure on the six (6) mirror apparatus, approximately one hundred four (104) MJ/m² TUVR on the (4) mirror apparatus, and approximately one hundred sixty-five (165) MJ/m² TUVR on the two (2) mirror apparatus.

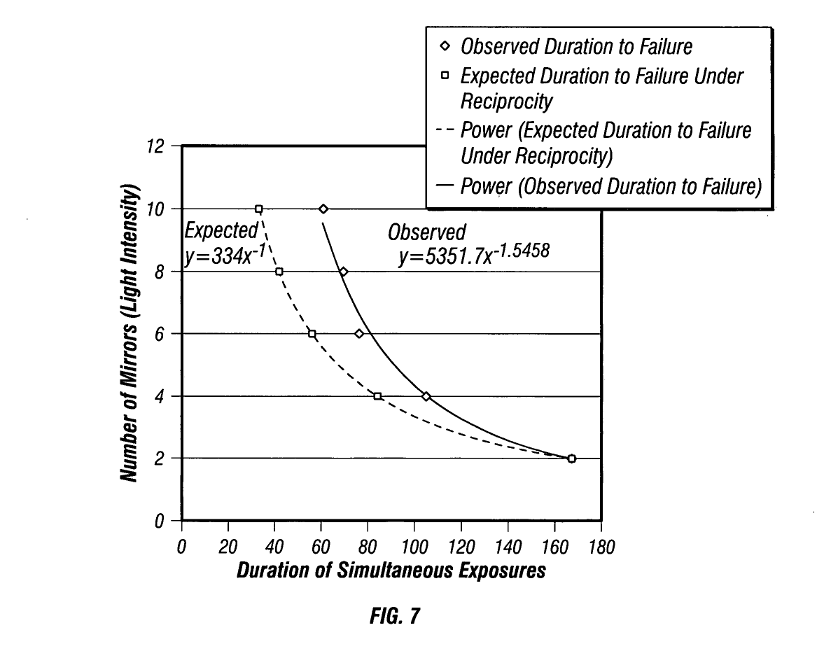

FIG. 7 is a graphical representation of the theoretical or expected weathering reciprocity correlation factor curve and observed weathering reciprocity correlation factor curve based on the test data from FIG. 6. The duration of the exposure required to cause failure is plotted on the x-axis as a function of the five (5) light intensities on the y-axis. If strict reciprocity were obeyed by the polystyrene in this embodiment of the present invention, one of skill in the art would expect that the duration of exposure required to produce a failure on the ten (10) mirror natural accelerated weathering test apparatus should be exactly one-fifth (⅕) the duration required to produce the same failure on the two (2) mirror apparatus. The theoretical or expected reciprocity function is normalized to the two (2) mirror apparatus observed data as shown by the curve labeled “Expected”. The actual observed empirical data is shown by the curve labeled “Observed,” which significantly deviates from strict reciprocity shown by the “Expected” curve.

It will be recognized that the deviation from the “Expected” or theoretical reciprocity and the characterization of the actual function or correlation factor describing observed light intensity/exposure time relationship is critical to accurately understanding a material's behavior under amplified solar radiation and intelligently developing accelerated weathering tests for such material.

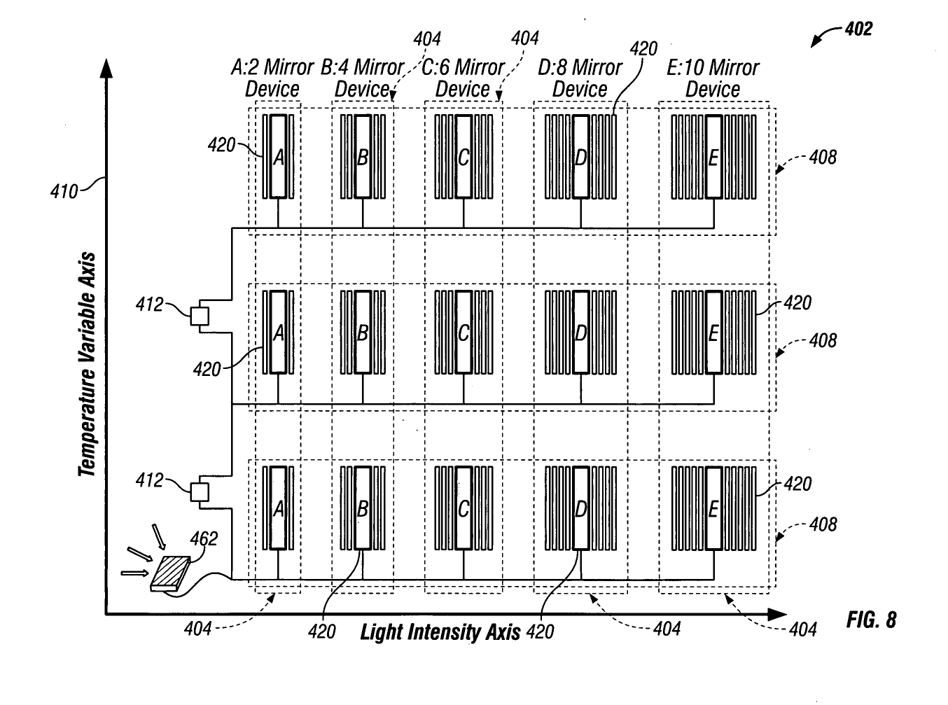

FIG. 8 illustrates a schematic representation of one embodiment of the assembly of the present invention showing an array 402 of natural accelerated weathering test apparatus 420, including a plurality of sets 404 thereof and a plurality of groups 408 thereof.

The assembly is useful for characterizing actual weathering reciprocity of the material. It includes an array 402 of natural accelerated weathering test apparatus 420 of the type used to concentrate solar radiation upon test specimens formed from the material. Each natural accelerated weathering test apparatus 420 includes a temperature control system (not shown in this illustration, but described above) for maintaining the test specimens at the desired temperature. The plurality of sets 404 of natural accelerated weathering test apparatus 420 are defined within the array 402. The test specimens in each set 404 are exposed to a different solar radiation intensity in accordance with any suitable structural and functional configuration, as described above. The plurality of groups 408 of natural accelerated weathering test apparatus 420 are defined in the array 402. The test specimens in each group 408 are maintained at a temperature offset relative to a desired temperature.

A method for characterizing weathering reciprocity of a material includes the following steps: configuring a plurality of natural accelerated weathering test apparatus 420 and the type used to concentrate solar radiation upon test specimens formed from the material in an array 402; connecting a temperature control system to each natural accelerated weathering test apparatus 420 disposed in the array 402; defining a plurality of sets 404 of natural accelerated weathering test apparatus 420 within the array 402; defining the plurality of groups 408 of natural accelerated weathering test apparatus 420 within the array 402; determining its desired temperature for the test specimens; exposing the test specimens in each set 404 to a different solar radiation intensity; and maintaining the test specimens in each group 408 at a temperature offset to the desired temperature.

The structure and function of this embodiment of the present invention is particularly useful for elucidating light dose/duration relationships of materials, exposure temperature/duration relationships of materials and the interactions (antagonism or synergism) between light dose/duration relationships and exposure temperature/duration relationships.

The first group 408 oriented as the low horizontal row with respect to the temperature variable axis 410 is structurally and functionally substantially identical, as described in the embodiment above. The second and third groups 408, shown in respective second and third horizontal rows of FIG. 8, are sequentially linked to the first group 408 by a trimming offset device 412 between each of the first and second groups and the second and third groups. The trimming offset device 412 applies an offset to the signal from the input device 462. The offset applied will be an absolute offset of a desired amount, a proportional offset in a desired proportion, a function offset, where a desired function is applied to the input device signal, or no offset. In one embodiment the same offset may be applied to each set 404 in each of the groups 408, so that orthogonal data may be obtained. The data obtained from such structure, and the functional operation thereof, enables generation of important degradation functions in terms of light intensity/time and exposure temperature/time variables.

In this embodiment of the present invention, three groups 408 are defined within the array 402. The first group, which is located at the lowest horizontal row on the temperature variable axis 410, operates having the tests specimens disposed therein at a first offset from the desired temperature. The second group, disposed immediately above the first group along the temperature variable axis 410, has test specimens at a second offset from the desired temperature. The third group, which is disposed immediately above the second group on the temperature variable axis 410, has test specimens at a third offset from the desired temperature. The first, second and third offsets are each one of an absolute offset, a proportional offset, a function offset and no offset. Generally, the first group operates at no offset to the desired temperature. It will be recognized by those of skill in the art that the present invention is not limited to three groups or five sets. Rather, such groups 408 and sets 404 may be configured and sized in an appropriate dimension in order to provide consistent, reliable and accurate data.

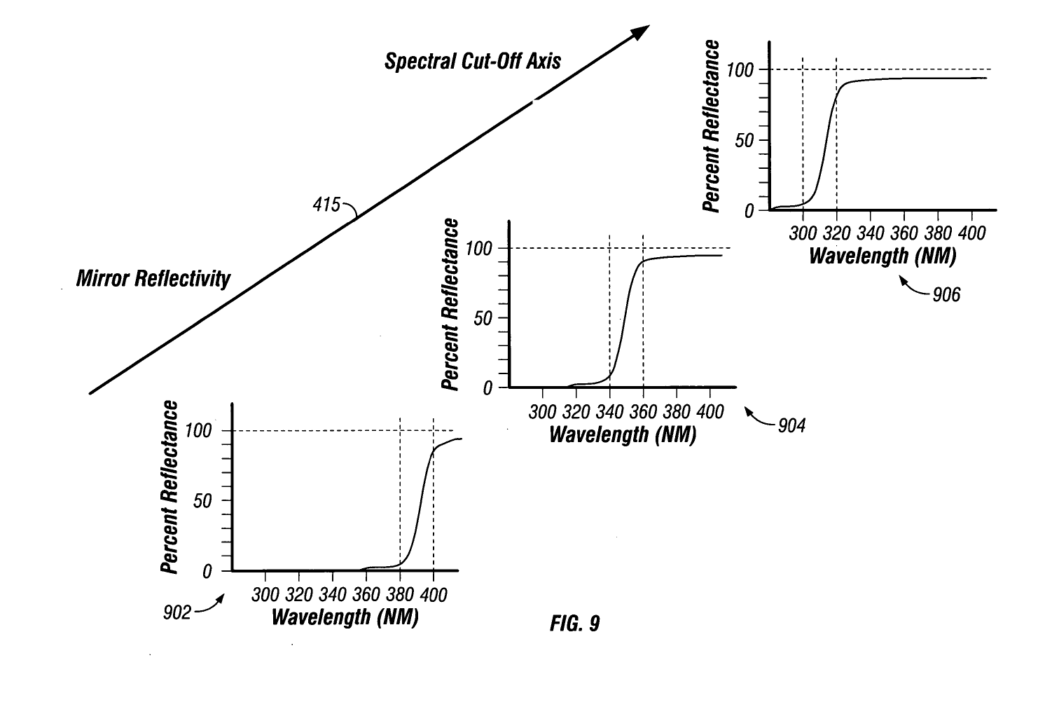

FIG. 9 is schematic representation of one aspect of one embodiment of the present invention, illustrating the characteristics of various cut-off filters, which may be used in accordance with such embodiment. As described in more detail below, by exposing the test specimens in different arrays to different ultraviolet spectral reflectivity, this embodiment of the present invention characterizes the effect of different light wavelengths on the degradation of a material.

A method of characterizing weathering reciprocity of a material based on this structure and function permits a user to quantify any synergy and antagonism between solar radiation intensity and solar spectral distribution on the weathering degradation of a material.

A first wavelength cut-off device or filter 902 is disposed at the lowest point along the mirror, reflectivity spectral cut-off axis 415. Generally, this filter accentuates reflectance in the 380-400 nanometer wavelength range. A second cut-off device, or filter 904, generally represents accentuated reflectance in the 340-360 nanometer wavelength range. A third cut-off device, or filter 906, generally illustrates an accentuated solar radiation wavelength range of 300-320 nanometers. The wavelength range may be a range, in the conventional understanding, between two points on a solar radiation spectrum. However, the wavelength range may also be a single point along the solar radiation spectrum. Accordingly, numerous filters or cut-off devices may be used, each having a different wavelength range, as defined above, in order to identify special sensitivity of the material.

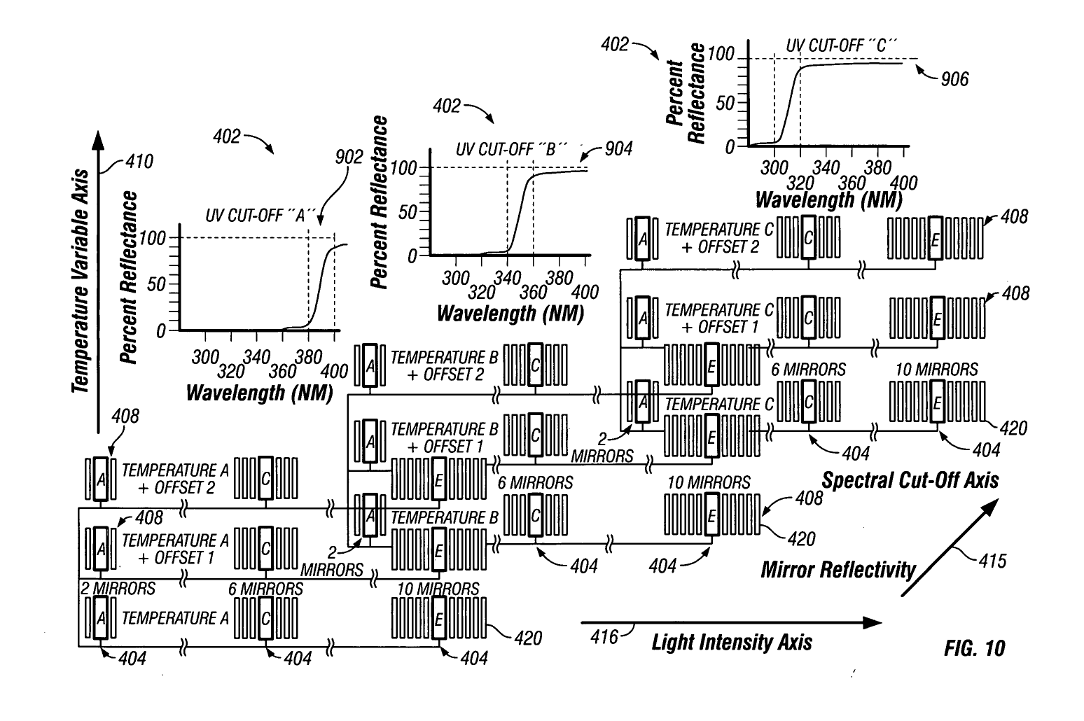

FIG. 10 is schematic representation of one embodiment of the present invention, illustrating a plurality of arrays 402 of natural accelerated weathering test apparatus 420. Each array 402 includes a plurality of sets 404 of natural accelerated weathering test apparatus 420 in a plurality of groups 408 of natural accelerated weathering test apparatus 420 and each natural accelerated weathering test apparatus 420 in each array includes a cut-off filter 902, 904 or 906.

An assembly for characterizing weathering reciprocity of a material in accordance with this embodiment of the present invention includes a plurality of arrays 402 of natural accelerated weathering test apparatus 420 of the type used to concentrate solar radiation upon test specimens formed from the material. Each natural accelerated weathering test apparatus 420 includes a temperature control system (not shown in this illustration, but described in detail above) for maintaining the test specimens at a desired temperature. A plurality of sets 404 of natural accelerated weathering test apparatus 420 are defined within each array 402. The test specimens in each set 404 are exposed to a different solar radiation intensity, as generally indicated by the light intensity axis 416. A plurality of groups 408 of natural accelerated weathering test apparatus 420 are defined within each array 402. The test specimens in each group 408 are maintained at a temperature offset relative to the desired temperature, as generally indicated by the temperature variable axis 410. The test specimens of each array 402 are exposed to a different desired solar radiation wavelength range, as indicated by the filter graphical representations 902, 904 and 906 associated with each array 402, which are spaced along the spectral cut-off axis 415.

The method for characterizing weathering reciprocity of a material in accordance with this embodiment of the present invention includes the following steps: configuring a plurality of natural accelerated weathering test apparatus of the type used to concentrate solar radiation upon test specimens formed from the material in a plurality of arrays 402; providing a temperature control system (not shown, but described in detail above) to each natural accelerated weathering test apparatus 420 disposed in each array 402; defining a plurality of sets natural accelerated weathering test apparatus within each array 402; defining a plurality of groups of natural accelerated weathering test apparatus within each array; determining a desired temperature for the test specimens; exposing the test specimens in each set to a different solar radiation intensity; maintaining the test specimens in each group at a temperature offset to the desired temperature; and exposing the test specimens in each array to a different desired solar radiation wavelength range.

The structural configuration and functional operation of this embodiment of the present invention enables investigators to elucidate light dose/duration relationships of materials, exposure temperature/duration relationships of materials, interactions between light dose/duration and exposure temperature/duration in relationships, solar spectral wavelength sensitivity of materials, interactions between light dose/duration and solar spectral sensitivity relationships, interactions between exposure temperatures/duration and solar spectral sensitivity and interactions between all three, i.e. light dose/duration and exposure temperature and spectral sensitivity relationships.

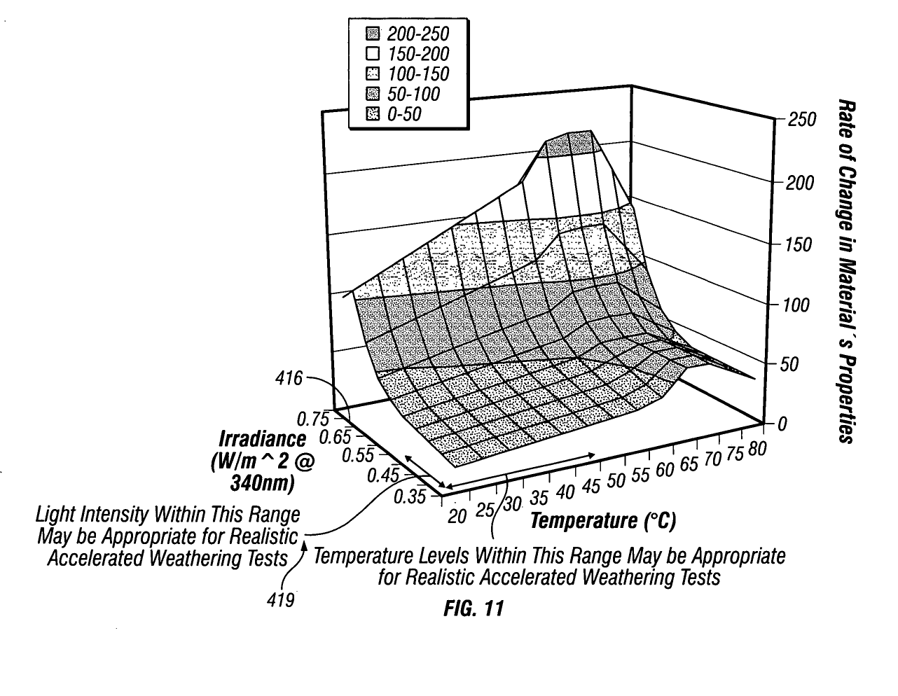

Data generated from the operation of the embodiment illustrated in FIG. 10 is generally illustrated in FIG. 11 for one wavelength range. The information presented in FIG. 11 is critical to the understanding of the material's behavior in accelerated weathering tests. Such information is useful to design faster and better accelerated weathering tests for specific materials. Such information can also be used to disqualify specific materials from being used in inappropriate accelerated weathering test. Only the simultaneous exposure of test specimens to multiple light intensity/exposure temperature combinations can hold the solar spectral power distributions constant across all exposure combinations. Note that the ultraviolet cut-off filter axis is not shown for clarity. The portion of the data transposed to the temperature/light intensity axes represents the linear region of the data for a specific material. The solar light intensity/exposure temperature level combinations disposed therein produce more realistic accelerated weathering tests for service life prediction and durability testing. Along the light intensity axis 416, light intensity amplification up to the level indicated by 419 may be appropriate for realistic accelerated weathering testing for such material. Light intensity amplification beyond such point may produce unrealistic results and errors in service life prediction.

It will be recognized by those with skill in the art that each array 402 is graphically represented in an abbreviated fashion in FIG. 10. This has been done for clarity and ease of presentation. Generally, each array would be configured as described above in detail, including a spectral ultraviolet cut-off filter as described with respect to FIG. 9. In this embodiment, each array includes a plurality of sets of natural accelerated weathering test apparatus 420 defined within such array that are exposed to different solar radiation intensity, as indicated by the light intensity axis 416. A plurality of groups of natural accelerated weathering test apparatus are also defined within such array such that the test specimens in each group are maintained at a temperature offset relative to the desired temperature, as indicated by the temperature variable axis 410. Additionally, each group in the array operates at either a desired temperature, the desired temperature plus an offset 1 or the desired temperature plus an offset 2. The test specimens in such array are exposed to a desired solar radiation wavelength range indicated by ultraviolet cut-off filter 902, 904 and 906.

It will be recognized by those with skill in the art that the present embodiment shown in FIG. 10 is only one possible embodiment therein useful to determine data for characterizing the weathering reciprocity of a material as shown in FIG. 11.

Various modifications and changes may be made by those skilled in the art without departing from the true spirit and scope of the invention, as defined by the depending claims. For example, mechanical or optical control devices may be substituted for the control and input signals and other methods to effect temperature, using the concentrating devices rather than blown air, may be used. For instance, a damper or mechanical valve in the air tunnel may be used to change the amount of cooling air circulated open test specimen. Finally, filters (polarizing, interference, tunable, etc.) may be used to effect the radiance and the temperature.

1. An assembly for characterizing weathering reciprocity of a material comprising:
an array of natural accelerated weathering test apparatus of the type used to concentrate solar radiation upon test specimens formed from the material;
each natural accelerated weathering test apparatus, including a temperature control system for maintaining the test specimens at a desired temperature; and
a plurality of sets of natural accelerated weathering test apparatus defined within the array, wherein the test specimens in each set are exposed to a different solar radiation intensity.

2. The assembly as recited in claim 1, wherein each natural accelerated weathering test apparatus further includes:
a target board for supporting the test specimens for exposure to the concentrated solar radiation;
a concentrating device for directing concentrated solar radiation intensity on to the target board for exposing the test specimens; and
an apparatus for adjusting a temperature of the test specimens to the desired temperature.

3. The assembly as recited in claim 1, wherein the temperature control system dynamically defines the desired temperature of the test specimens to simulate complex temperature cycles of an end-use application of the material.

4. The assembly as recited in claim 1, wherein each of the plurality of sets includes at least one natural accelerated weathering test apparatus.

5. The assembly as recited in claim 1, wherein each natural accelerated weathering test apparatus further includes a concentrating device for directing concentrated solar radiation intensity upon the test specimens.

6. The assembly as recited in claim 5, wherein each concentrating device includes at least one concentrating element.

7. The assembly as recited in claim 5, wherein each concentrating device includes a number of concentrating elements CE such that the number of concentrating elements CE is directly proportional to a number of each set S of the plurality of sets, whereby the number of concentrating elements is determined from the equation: CE=S.

8. The assembly as recited in claim 5, wherein each concentrating device includes a number of concentrating elements CE such that the number of concentrating elements CE is proportional to a number of each set S of the plurality of sets, whereby the number of concentrating elements is determined from the equation: CE=S*2.

9. The assembly as recited in claim 8, wherein a first set includes two concentrating elements; a second set includes four concentrating elements; a third set includes six concentrating elements; a fourth set includes eight concentrating elements; and a fifth set includes ten concentrating elements.

10. The assembly as recited in claim 6, wherein each concentrating element may be adjusted with respect to the test specimens in order to provide the different solar radiation intensity.

11. The assembly as recited in claim 5, wherein each concentrating device has a focal length which may be adjusted with respect to the test specimens in order to provide the different solar radiation intensity.

12. The assembly as recited in claim 1, wherein the temperature control system includes:
an input device which continuously generates a dynamic reference signal representative of a complex temperature cycle of an end-use application of the material; and
a controller connected to the input device such that the controller is responsive to the dynamic reference signal for selectively maintaining the desired temperature.

13. The assembly as recited in claim 12, wherein the input device of a first natural accelerated weathering test apparatus is disposed remote from the array.

14. The assembly as recited in claim 13, wherein the input device of each other natural accelerated weathering test apparatus consecutively links in series the first one natural accelerated weathering test apparatus and the other natural accelerated weathering test apparatus of the array such that the other natural accelerated weathering test apparatus are dependently controlled from the first one natural accelerated weathering test apparatus.

15. The assembly as recited in claim 13, wherein the input device of each other natural accelerated weathering test apparatus is connected to the first one natural accelerated weathering test apparatus.

16. The assembly cited by claim 12, wherein the input device is one of a temperature sensitive component, an apparatus for replaying a recorded environment temperature cycle, an apparatus for generating a complex temperature cycle and a non-contact monitoring device.

17. The assembly as recited in claim 2, wherein the temperature control system includes:
a feedback device mounted to the target board for exposure to the concentrated solar radiation and generating a test signal responsive to a temperature thereof and representative of a test specimen temperature;
an input device for continuously generating a dynamic reference signal representative of a complex temperature cycle of an end-use application of the material; and
a controller connected to the input device and the feedback device; the controller responsive to the dynamic reference signal and the test signal for generating a control signal representative of the desired temperature for selectively controlling the apparatus in order to control adjustment of the temperature of the test specimen to the desired temperature, the adjustment being generally increased when the test specimen temperature is greater than the desired temperature, and the adjustment being generally decreased when the test specimen temperature is less than the desired temperature, and the adjustment being generally maintained constant when the test specimen temperature is substantially equal to the desired temperature.

18. The assembly cited by claim 17, wherein the input device is one of a temperature sensitive component, an apparatus for replaying a recorded environment temperature cycle, an apparatus for generating a complex temperature cycle and a non-contact monitoring device.

19. The assembly recited by claim 17, wherein the feedback device is one of a temperature sensitive component and a non-contact monitoring device.

20. The assembly recited by claim 17, wherein the feedback device is connected in a heat conductive relationship to a panel mounted to the target board.

21. The assembly recited by claim 20, wherein the feedback device further includes a black coating overlying the feedback device and the panel for absorbing the solar radiation intensity impinging thereon.

22. The assembly as recited in claim 17, wherein the apparatus includes an air circulation device for moving ambient air over the target board, said air circulation device including an electric motor and a fan powered by the electric motor for creating a flow of ambient air.

23. The assembly as recited in claim 17, wherein the apparatus includes a base contiguous with the test specimens and at least one fin which extends from the base into an air tunnel having a fan for moving air therethrough in order to dissipate heat from the specimen to air moved through the air tunnel by the fan.

24. The assembly as recited in claim 23, wherein the apparatus is a metallic heat sink.

25. The assembly as recited in claim 17, wherein the apparatus includes a base contiguous with the test specimens, at least two legs which extend from the base into an air tunnel having a fan for moving air therethrough in order to dissipate heat from the test specimens to the air moving through the air tunnel, a top connected to each leg having a first end and a second end and a voltage source applied across the first and second ends of the top.

26. The assembly as recited in claim 25, wherein adjacent legs are constructed of dissimilar semiconductor material.

27. The assembly as recited in claim 17, wherein the apparatus includes a flexible walled vessel containing a coolant adequate to adjust the desired temperature of the test specimens wherein the flexible walled vessel conforms to the test specimens as a result of the coolant disposed therein.

28. The assembly as recited in claim 27, wherein the flexible walled vessel is operatively connected to an inlet in communication with a coolant source and an outlet regulated to remove the coolant from the flexible walled vessel at a desired rate.

29. The assembly as recited in claim 27, wherein the coolant is selected from the group consisting essentially of refrigerated air, ethylene glycol, fluorocarbon refrigerants, alcohol, refrigerant gases and fluids used for heat exchange.

30. An assembly for characterizing weathering reciprocity of a material comprising:
an array of natural accelerated weathering test apparatus of the type used to concentrate solar radiation upon test specimens formed from the material;
each natural accelerated weathering test apparatus including a temperature control system for maintaining the test specimens at a desired temperature;
a plurality of sets of natural accelerated weathering test apparatus defined within the array;
the test specimens in each set exposed to a different solar radiation intensity;
a plurality of groups of natural accelerated weathering test apparatus defined within the array; and
the test specimens in each group maintained at a temperature offset relative to the desired temperature.

31. The assembly as recited in claim 30, wherein each natural accelerated weathering test apparatus further includes:
a target board for supporting the test specimens for exposure to the concentrated solar radiation;
a concentrating device for directing concentrated solar radiation intensity on to the target board for exposing the test specimens; and
an apparatus for adjusting the temperature of the test specimens to the desired temperature.

32. The assembly as recited in claim 30, wherein the temperature control system dynamically defines the desired temperature of the test specimens to simulate complex temperature cycles of an end-use application of the material.

33. The assembly as recited in claim 30, wherein each of the plurality of sets includes at least one natural accelerated weathering test apparatus.

34. The assembly as recited in claim 30, wherein each natural accelerated weathering test apparatus further includes a concentrating device for directing concentrated solar radiation intensity upon the test specimens.

35. The assembly as recited in claim 34, wherein each concentrating device includes at least one concentrating element.

36. The assembly as recited in claim 34, wherein each concentrating device includes a number of concentrating elements CE such that the number of concentrating elements CE is directly proportional to a number of each set S of the plurality of sets, whereby the number of concentrating elements is determined from the equation: CE=S.

37. The assembly as recited in claim 34, wherein each concentrating device includes a number of concentrating elements CE such that the number of concentrating elements CE is proportional to a number of each set S of the plurality of sets, whereby the number of concentrating elements is determined from the equation: CE=S*2.

38. The assembly as recited in claim 37, wherein a first set includes two concentrating elements; a second set includes four concentrating elements; a third set includes six concentrating elements; a fourth set includes eight concentrating elements; and a fifth set includes ten concentrating elements.

39. The assembly as recited in claim 35, wherein each concentrating element may be adjusted with respect to the test specimens in order to provide the different solar radiation intensity.

40. The assembly as recited in claim 34, wherein each concentrating device has a focal length which may be adjusted with respect to the test specimens in order to provide the different solar radiation intensity.

41. The assembly as recited in claim 30, wherein the temperature control system includes:
an input device which continuously generates a dynamic reference signal representative of a complex temperature cycle of an end-use application of the material; and
a controller connected to the input device such that the controller is responsive to the dynamic reference signal for selectively maintaining the desired temperature.

42. The assembly as recited in claim 41, wherein the input device of a first one natural accelerated weathering test apparatus is disposed remote from the array.

43. The assembly as recited in claim 42, wherein the input device of each other natural accelerated weathering test apparatus consecutively links in series the first one natural accelerated weathering test apparatus and the other natural accelerated weathering test apparatus of the array such that the other natural accelerated weathering test apparatus are dependently controlled from the first one natural accelerated weathering test apparatus.

44. The assembly as recited in claim 42, wherein the input device of each other natural accelerated weathering test apparatus is connected to the first one natural accelerated weathering test apparatus.

45. The assembly cited by claim 41, wherein the input device is one of a temperature sensitive component, an apparatus for replaying a recorded environment temperature cycle, an apparatus for generating a complex temperature cycle and a non-contact monitoring device.

46. The assembly as recited in claim 31, wherein the temperature control system includes:
a feedback device mounted to the target board for exposure to the concentrated solar radiation and generating a test signal responsive to a temperature thereof and representative of a test specimen temperature;
an input device for continuously generating a dynamic reference signal representative of a complex temperature cycle of an end-use application of the material; and
a controller connected to the input device and the feedback device; the controller responsive to the dynamic reference signal and the test signal for generating a control signal representative of the desired temperature for selectively controlling the apparatus in order to control adjustment of the temperature of the test specimen to the desired temperature, the adjustment being generally increased when the test specimen temperature is greater than the desired temperature, and the adjustment being generally decreased when the test specimen temperature is less than the desired temperature, and the adjustment being generally maintained constant when the test specimen temperature is substantially equal to the desired temperature.

47. The assembly cited by claim 46, wherein the input device is one of a temperature sensitive component, an apparatus for replaying a recorded environment temperature cycle, an apparatus for generating a complex temperature cycle and a non-contact monitoring device.

48. The assembly recited by claim 46, wherein the feedback device is one of a temperature sensitive component and a non-contact monitoring device.

49. The assembly as recited in claim 46, wherein the apparatus includes an air circulation device for moving ambient air over the target board, said air circulation device including an electric motor and a fan powered by the electric motor for creating a flow of ambient air.

50. The assembly as recited in claim 46, wherein the feedback device is connected in a heat conductive relationship to a panel mounted to the target board.

51. The assembly as recited in claim 46, wherein the feedback device further includes a black coating overlying the feedback device and the panel for absorbing the solar radiation intensity impinging thereon.

52. The assembly as recited in claim 46, wherein the apparatus includes a base contiguous with the test specimens and at least one fin which extends from the base into an air tunnel having a fan for moving air therethrough in order to dissipate heat from the specimen to air moved through the air tunnel by the fan.

53. The assembly as recited in claim 52, wherein the apparatus is a metallic heat sink.

54. The assembly as recited in claim 46, wherein the apparatus includes a base contiguous with the test specimens, at least two legs which extend from the base into an air tunnel having a fan for moving air therethrough in order to dissipate heat from the test specimens to the air moving through the air tunnel, a top connected to each leg having a first end and a second end and a voltage source applied across the first and second ends of the top.

55. The assembly as recited in claim 54, wherein adjacent legs are constructed of dissimilar semiconductor material.

56. The assembly as recited in claim 46, wherein the apparatus includes a flexible walled vessel containing a coolant adequate to adjust the desired temperature of the test specimens wherein the flexible walled vessel conforms to the test specimens as a result of the coolant disposed therein.

57. The assembly as recited in claim 56, wherein the flexible walled vessel is operatively connected to an inlet in communication with a coolant source and an outlet regulated to remove the coolant from the flexible walled vessel at a desired rate.

58. The assembly as recited in claim 56, wherein the coolant is selected from the group consisting essentially of refrigerated air, ethylene glycol, fluorocarbon refrigerants, alcohol, refrigerant gases and fluids used for heat exchange.

59. The assembly as recited in claim 30, wherein the offset is one of an absolute offset, a proportional offset, a function offset and no offset.

60. The assembly as recited in claim 41, wherein the controller further includes an offset device for applying the offset to the desired temperature.

61. The assembly as recited in claim 60, wherein the offset is one of an absolute offset, a proportional offset, a function offset and no offset.

62. The assembly as recited in claim 46, wherein the controller further includes an offset device for applying an offset to the desired temperature.

63. The assembly as recited in claim 62, wherein the offset is one of an absolute offset, a proportional offset, a function offset and no offset.

64. The assembly as recited in claim 30, wherein each group includes at least one natural accelerated weathering test apparatus from each set.

65. The assembly as recited in claim 30, wherein the plurality of groups includes:
a first group having test specimens at a first offset from the desired temperature;
a second group having test specimens at a second offset from the desired temperature; and
a third group having test specimens at a third offset from the desired temperature.

66. The assembly as recited in claim 65, wherein the first, second and third offsets are each one of an absolute offset, a proportional offset, a function offset and no offset.

67. An assembly for characterizing weathering reciprocity of a material comprising:
a plurality of arrays of natural accelerated weathering test apparatus of the type used to concentrate solar radiation upon test specimens formed from the material;
each natural accelerated weathering test apparatus including a temperature control system for maintaining the test specimens at a desired temperature;
a plurality of sets of natural accelerated weathering test apparatus defined within each array;
the test specimens in each set exposed to a different solar radiation intensity;
a plurality of groups of natural accelerated weathering test apparatus defined within each array;
the test specimens in each group maintained at a temperature offset relative to the desired temperature; and
the test specimens of each array exposed to a different desired solar radiation wavelength range.

68. The assembly as recited in claim 67, wherein each natural accelerated weathering test apparatus further includes:
a target board for supporting the test specimens for exposure to the concentrated solar radiation;
a concentrating device for directing concentrated solar radiation intensity on to the target board for exposing the test specimens; and
an apparatus for adjusting a temperature of the test specimens to the desired temperature.

69. The assembly as recited in claim 67, wherein the temperature control system dynamically defines the desired temperature of the test specimens to simulate complex temperature cycles of an end-use application of the material.

70. The assembly as recited in claim 67, wherein each of the plurality of sets includes at least one natural accelerated weathering test apparatus.

71. The assembly as recited in claim 67, wherein each natural accelerated weathering test apparatus further includes a concentrating device for directing concentrated solar radiation intensity upon the test specimens.

72. The assembly as recited in claim 71, wherein each concentrating device includes at least one concentrating element.

73. The assembly as recited in claim 71, wherein each concentrating device includes a number of concentrating elements CE such that the number of concentrating elements CE is directly proportional to a number of each set S of the plurality of sets, whereby the number of concentrating elements is determined from the equation: CE=S.

74. The assembly as recited in claim 71, wherein each concentrating device includes a number of concentrating elements CE such that the number of concentrating elements CE is proportional to a number of each set S of the plurality of sets, whereby the number of concentrating elements is determined from the equation: CE=S*2.

75. The assembly as recited in claim 74, wherein a first set includes two concentrating elements; a second set includes four concentrating elements; a third set includes six concentrating elements; a fourth set includes eight concentrating elements; and a fifth set includes ten concentrating elements.

76. The assembly as recited in claim 72, wherein each concentrating element may be adjusted with respect to the test specimens in order to provide the different solar radiation intensity.

77. The assembly as recited in claim 71, wherein each concentrating device has a focal length which may be adjusted with respect to the test specimens in order to provide the different solar radiation intensity.

78. The assembly as recited in claim 67, wherein the temperature control system includes:
an input device which continuously generates a dynamic reference signal representative of a complex temperature cycle of an end-use application of the material; and
a controller connected to the input device such that the controller is responsive to the dynamic reference signal for selectively maintaining the desired temperature.

79. The assembly as recited in claim 78, wherein the input device of a first one natural accelerated weathering test apparatus is disposed remote from the array.

80. The assembly as recited in claim 79, wherein the input device of each other natural accelerated weathering test apparatus consecutively links in series the first one natural accelerated weathering test apparatus and the other natural accelerated weathering test apparatus of the array such that the other natural accelerated weathering test apparatus are dependently controlled from the first one natural accelerated weathering test apparatus.

81. The assembly as recited in claim 79, wherein the input device of each other natural accelerated weathering test apparatus is connected to the first one natural accelerated weathering test apparatus.

82. The assembly cited by claim 78, wherein the input device is one of a temperature sensitive component, an apparatus for replaying a recorded environment temperature cycle, an apparatus for generating a complex temperature cycle and a non-contact monitoring device.

83. The assembly as recited in claim 68, wherein the temperature control system includes:
a feedback device mounted to the target board for exposure to the concentrated solar radiation and generating a test signal responsive to a temperature thereof and representative of a test specimen temperature;
an input device for continuously generating a dynamic reference signal representative of a complex temperature cycle of an end-use application of the material; and
a controller connected to the input device and the feedback device; the controller responsive to the dynamic reference signal and the test signal for generating a control signal representative of the desired temperature for selectively controlling the apparatus in order to control adjustment of the temperature of the test specimens to the desired temperature, the adjustment being generally increased when the test specimen temperature is greater than the desired temperature, and the adjustment being generally decreased when the test specimen temperature is less than the desired temperature, and the adjustment being generally maintained constant when the test specimen temperature is substantially equal to the desired temperature.

84. The assembly cited by claim 83, wherein the input device is one of a temperature sensitive component, an apparatus for replaying a recorded environment temperature cycle, an apparatus for generating a complex temperature cycle and a non-contact monitoring device.

85. The assembly recited by claim 83, wherein the feedback device is one of a temperature sensitive component and a non-contact monitoring device.

86. The assembly as recited in claim 83, wherein the apparatus includes an air circulation device for moving ambient air over the target board, said air circulation device including an electric motor and a fan powered by the electric motor for creating a flow of ambient air.

87. The assembly as recited in claim 83, wherein the feedback device is connected in a heat conductive relationship to a panel mounted to the target board.

88. The assembly as recited in claim 83, wherein the feedback device further includes a black coating overlying the feedback device and the panel for absorbing the solar radiation intensity impinging thereon.

89. The assembly as recited in claim 83, wherein the apparatus includes a base contiguous with the test specimens and at least one fin which extends from the base into an air tunnel having a fan for moving air therethrough in order to dissipate heat from the specimen to air moved through the air tunnel by the fan.

90. The assembly as recited in claim 89, wherein the apparatus is a metallic heat sink.

91. The assembly as recited in claim 83, wherein the apparatus includes a base contiguous with the test specimens, at least two legs which extend from the base into an air tunnel having a fan for moving air therethrough in order to dissipate heat from the test specimens to the air moving through the air tunnel, a top connected to each leg having a first end and a second end and a voltage source applied across the first and second ends of the top.

92. The assembly as recited in claim 91, wherein adjacent legs are constructed of dissimilar semiconductor material.

93. The assembly as recited in claim 83, wherein the apparatus includes a flexible walled vessel containing a coolant adequate to adjust the desired temperature of the test specimens wherein the flexible walled vessel conforms to the test specimens as a result of the coolant disposed therein.

94. The assembly as recited in claim 93, wherein the flexible walled vessel is operatively connected to an inlet in communication with a coolant source and an outlet regulated to remove the coolant from the flexible walled vessel at a desired rate.

95. The assembly as recited in claim 93, wherein the coolant is selected from the group consisting essentially of refrigerated air, ethylene glycol, fluorocarbon refrigerants, alcohol, refrigerant gases and fluids used for heat exchange.

96. The assembly as recited in claim 67, wherein the offset is one of an absolute offset, a proportional offset, a function offset and no offset.

97. The assembly as recited in claim 78, wherein the controller further includes an offset device for applying the offset to the desired temperature.

98. The assembly as recited in claim 97, wherein the offset applied to the desired temperature is one of an absolute offset, a proportional offset, a function offset and no offset.

99. The assembly as recited in claim 83, wherein the controller further includes an offset device for applying an offset to the desired temperature.

100. The assembly as recited in claim 99, wherein the offset applied to the desired temperature is one of an absolute offset, a proportional offset, a function offset and no offset.

101. The assembly as recited in claim 67, wherein each group includes at least one natural accelerated weathering test apparatus from each set.

102. The assembly as recited in claim 67, wherein the plurality of groups includes:
a first group having test specimens at a first offset from the desired temperature;
a second group having test specimens at a second offset from the desired temperature; and
a third group having test specimens at a third offset from the desired temperature.

103. The assembly as recited in claim 102, wherein the first, second and third offsets are each one of an absolute offset, a proportional offset, a function offset and no offset.

104. The assembly as recited in claim 67, wherein the plurality of arrays includes:
a first array having test specimens exposed to a first preselected wavelength range;
a second array having test specimens exposed to a second preselected wavelength range; and
a third array having test specimens exposed to a third preselected wavelength range.

105. A method for characterizing weathering reciprocity of a material comprising:
configuring a plurality of natural accelerated weathering test apparatus of the type used to concentrate solar radiation upon test specimens formed from the material in an array;
connecting a temperature control system to each natural accelerated weathering test apparatus disposed in the array;
defining a plurality of sets of natural accelerated weathering test apparatus within the array;
maintaining the test specimens at a desired temperature; and
exposing the test specimens in each set to a different solar radiation intensity.

106. The method as recited in claim 105, wherein the desired temperature is dynamically defined by the temperature control system to simulate complex temperature cycles of an end-use application of the material.

107. The method as recited in claim 105, wherein each natural accelerated weathering test apparatus further includes a concentrating device for directing concentrated solar radiation intensity upon the test specimens.

108. The method as recited in claim 107, wherein each concentrating device includes at least one concentrating element.

109. The method as recited in claim 107, wherein each concentrating device includes a number of concentrating elements CE such that the number of concentrating elements CE is directly proportional to a number of each set S of the plurality of sets, whereby the number of concentrating elements is determined from the equation: CE=S.

110. The method as recited in claim 107, wherein each concentrating device includes a number of concentrating elements CE such that the number of concentrating elements CE is proportional to a number of each set S of the plurality of sets, whereby the number of concentrating elements is determined from the equation: CE=S*2.

111. The method as recited in claim 110, wherein a first set includes two concentrating elements; a second set includes four concentrating elements; a third set includes six concentrating elements; a fourth set includes eight concentrating elements; and a fifth set includes ten concentrating elements.

112. The method as recited in claim 108, wherein the step of exposing the test specimens comprises configuring each set in the array such that the concentrating devices in each set have a different number of concentrating elements.

113. The method as recited in claim 108, wherein each concentrating element may be adjusted with respect to the test specimens in order to provide the different solar radiation intensity.

114. The method as recited in claim 107, wherein each concentrating device has a focal length which may be adjusted with respect to the test specimens in order to provide the different solar radiation intensity.

115. A method for characterizing weathering reciprocity of a material comprising:
configuring a plurality of natural accelerated weathering test apparatus of the type used to concentrate solar radiation upon test specimens formed form the material in an array;
connecting a temperature control system to each natural accelerated weathering test apparatus disposed in the array;
defining a plurality of sets of natural accelerated weathering test apparatus within the array;
defining a plurality of groups of natural accelerated weathering test apparatus within the array;
determining a desired temperature for the test specimens;
exposing the test specimens in each set to a different solar radiation intensity; and
maintaining the test specimens in each group at a temperature offset to the desired temperature.

116. The method as recited in claim 115, wherein the desired temperature is dynamically defined by the temperature control system to simulate complex temperature cycles of an end-use application of the material.

117. The method as recited in claim 115, wherein each natural accelerated weathering test apparatus further includes a concentrating device for directing concentrated solar radiation intensity upon the test specimens.

118. The method as recited in claim 117, wherein each concentrating device includes at least one concentrating element.

119. The method as recited in claim 117, wherein each concentrating device includes a number of concentrating elements CE such that the number of concentrating elements CE is directly proportional to a number of each set S of the plurality of sets, whereby the number of concentrating elements is determined from the equation: CE=S.

120. The method as recited in claim 117, wherein each concentrating device includes a number of concentrating elements CE such that the number of concentrating elements CE is proportional to a number of each set S of the plurality of sets, whereby the number of concentrating elements is determined from the equation: CE=S*2.

121. The method as recited in claim 120, wherein a first set includes two concentrating elements; a second set includes four concentrating elements; a third set includes six concentrating elements; a fourth set includes eight concentrating elements; and a fifth set includes ten concentrating elements.

122. The method as recited in claim 118, wherein the step of exposing the test specimens comprises configuring each set in the array such that the concentrating devices in each set have a different number of concentrating elements.

123. The method as recited in claim 118, wherein each concentrating element may be adjusted with respect to the test specimens in order to provide the different solar radiation intensity.

124. The method as recited in claim 117, wherein each concentrating device has a focal length which may be adjusted with respect to the test specimens in order to provide the different solar radiation intensity.

125. The method as recited in claim 115, wherein the temperature control system includes:
an input device which continuously generates a dynamic reference signal representative of a complex temperature cycle of an end-use application of the material; and
a controller connected to the input device such that the controller is responsive to the dynamic reference signal for selectively maintaining the desired temperature.

126. The method as recited in claim 125, wherein the input device of a first one natural accelerated weathering test apparatus is disposed remote from the array.

127. The method as recited in claim 126, wherein the input device of each other natural accelerated weathering test apparatus consecutively links in series the first one natural accelerated weathering test apparatus and the other natural accelerated weathering test apparatus of the array such that the other natural accelerated weathering test apparatus are dependently controlled from the first one natural accelerated weathering test apparatus.

128. The, method as recited in claim 126, wherein the input device of each other natural accelerated weathering test apparatus is connected to the first one natural accelerated weathering test apparatus.

129. The method cited by claim 125, wherein the input device is one of a temperature sensitive component, an apparatus for replaying a recorded environment temperature cycle, an apparatus for generating a complex temperature cycle and a non-contact monitoring device.

130. The method as recited in claim 125, wherein each natural accelerated weathering test apparatus further including:
a target board for supporting the test specimens for exposure to the concentrated solar radiation;
a concentrating device for directing concentrated solar radiation intensity on to the target board for exposing the test specimens; and
an apparatus for adjusting the temperature of the test specimens to the desired temperature.

131. The method as recited in claim 130, wherein the temperature control system includes:
a feedback device mounted to the target board for exposure to the concentrated solar radiation and generating a test signal responsive to a temperature thereof and representative of a test specimen temperature;
an input device for continuously generating a dynamic reference signal representative of a complex temperature cycle of an end-use application of the material; and
a controller connected to the input device and the feedback device; the controller responsive to the dynamic reference signal and the test signal for generating a control signal representative of the desired temperature for selectively controlling the apparatus in order to control adjustment of the temperature of the test specimens to the desired temperature, the adjustment being generally increased when the test specimen temperature is greater than the desired temperature, and the adjustment being generally decreased when the test specimen temperature is less than the desired temperature, and the adjustment being generally maintained constant when the test specimen temperature is substantially equal to the desired temperature.

132. The method cited by claim 131, wherein the input device is one of a temperature sensitive component, an apparatus for replaying a recorded environment temperature cycle, an apparatus for generating a complex temperature cycle and a non-contact monitoring device.

133. The method recited by claim 131, wherein the feedback device is one of a temperature sensitive component and a non-contact monitoring device.

134. The method as recited in claim 131, wherein the apparatus includes an air circulation device for moving ambient air over the target board, said air circulation device including an electric motor and a fan powered by the electric motor for creating a flow of ambient air.

135. The method as recited in claim 131, wherein the feedback device is connected in a heat conductive relationship to a panel mounted to the target board.

136. The method as recited in claim 131, wherein the feedback device further includes a black coating overlying the feedback device and the panel for absorbing the solar radiation intensity impinging thereon.

137. The method as recited in claim 131, wherein the apparatus includes a base contiguous with the test specimens and at least one fin which extends from the base into an air tunnel having a fan for moving air therethrough in order to dissipate heat from the specimen to air moved through the air tunnel by the fan.

138. The method as recited in claim 137, wherein the apparatus is a metallic heat sink.

139. The method as recited in claim 131, wherein the apparatus includes a base contiguous with the test specimens, at least two legs which extend from the base into an air tunnel having a fan for moving air therethrough in order to dissipate heat from the test specimens to the air moving through the air tunnel, a top connected to each leg having a first end and a second end and a voltage source applied across the first and second ends of the top.

140. The method as recited in claim 139, wherein adjacent legs are constructed of dissimilar semiconductor material.

141. The method as recited in claim 131, wherein the apparatus includes a flexible walled vessel containing a coolant adequate to adjust the desired temperature of the test specimens wherein the flexible walled vessel conforms to the test specimens as a result of the coolant disposed therein.

142. The method as recited in claim 141, wherein the flexible walled vessel is operatively connected to an inlet in communication with a coolant source and an outlet regulated to remove the coolant from the flexible walled vessel at a desired rate.

143. The method as recited in claim 141, wherein the coolant is selected from the group consisting essentially of refrigerated air, ethylene glycol, fluorocarbon refrigerants, alcohol, refrigerant gases and fluids used for heat exchange.

144. The method as recited in claim 115, wherein the offset is one of an absolute offset, a proportional offset, a function offset and no offset.

145. The method as recited in claim 125, wherein the controller further includes an offset device for applying the offset to the desired temperature.

146. The method as recited in claim 145, wherein the offset is one of an absolute offset, a proportional offset, a function offset and no offset.

147. The method as recited in claim 131, wherein the controller further includes an offset device for applying an offset to the desired temperature.

148. The method as recited in claim 147, wherein the offset is one of an absolute offset, a proportional offset, a function offset and no offset.

149. The method as recited in claim 115, wherein each group includes at least one natural accelerated weathering test apparatus from each set.

150. The method as recited in claim 115, wherein the plurality of groups includes:
a first group having test specimens at a first offset from the desired temperature;
a second group having test specimens at a second offset from the desired temperature; and
a third group having test specimens at a third offset from the desired temperature.

151. The method as recited in claim 150, wherein the first, second and third offsets are each one of an absolute offset, a proportional offset, a function offset and no offset.

152. A method for characterizing weathering reciprocity of a material comprising:
configuring a plurality of natural accelerated weathering test apparatus of the type used to concentrate solar radiation upon test specimens formed from the material in a plurality of arrays;
connecting a temperature control system to each natural accelerated weathering test apparatus disposed in each array;
defining a plurality of sets of natural accelerated weathering test apparatus within each array;
defining a plurality of groups of natural accelerated weathering test apparatus within each array;
determining a desired temperature for the test specimens;
exposing the test specimens in each set to a different solar radiation intensity;
maintaining the test specimens in each group at a temperature offset to the desired temperature; and
exposing the test specimens in each array to a different desired solar radiation wavelength range.

153. The method as recited in claim 152, wherein the desired temperature is dynamically defined by the temperature control system to simulate complex temperature cycles of an end-use application of the material.

154. The method as recited in claim 152, wherein each natural accelerated weathering test apparatus further includes a concentrating device for directing concentrated solar radiation intensity upon the test specimens.

155. The method as recited in claim 154, wherein each concentrating device includes at least one concentrating element.

156. The method as recited in claim 154, wherein each concentrating device includes a number of concentrating elements CE such that the number of concentrating elements CE is directly proportional to a number of each set S of the plurality of sets, whereby the number of concentrating elements is determined from the equation: CE=S.

157. The method as recited in claim 154, wherein each concentrating device includes a number of concentrating elements CE such that the number of concentrating elements CE is proportional to a number of each set S of the plurality of sets, whereby the number of concentrating elements is determined from the equation: CE=S*2.

158. The method as recited in claim 157, wherein a first set includes two concentrating elements; a second set includes four concentrating elements; a third set includes six concentrating elements; a fourth set includes eight concentrating elements; and a fifth set includes ten concentrating elements.

159. The method as recited in claim 155, wherein the step of exposing the test specimens comprises configuring each set in the array such that the concentrating devices in each set have a different number of concentrating elements.

160. The method as recited in claim 155, wherein each concentrating element may be adjusted with respect to the test specimens in order to provide the different solar radiation intensity.

161. The method as recited in claim 154, wherein each concentrating device has a focal length that may be adjusted with respect to the test specimens in order to provide the different solar radiation intensity.

162. The method as recited in claim 152, wherein the temperature control system includes:
an input device which continuously generates a dynamic reference signal representative of a complex temperature cycle of an end-use application of the material; and
a controller connected to the input device such that the controller is responsive to the dynamic reference signal for selectively maintaining the desired temperature.

163. The method as recited in claim 162, wherein the input device of a first one natural accelerated weathering test apparatus is disposed remote from the array.

164. The method as recited in claim 163, wherein the input device of each other natural accelerated weathering test apparatus consecutively links in series the first one natural accelerated weathering test apparatus and the other natural accelerated weathering test apparatus of the array such that the other natural accelerated weathering test apparatus are dependently controlled from the first one natural accelerated weathering test apparatus.

165. The method as recited in claim 163, wherein the input device of each other natural accelerated weathering test apparatus is connected to the first one natural accelerated weathering test apparatus.

166. The method cited by claim 162, wherein the input device is one of a temperature sensitive component, an apparatus for replaying a recorded environment temperature cycle, an apparatus for generating a complex temperature cycle and a non-contact monitoring device.

167. The method as recited in claim 152, wherein each natural accelerated weathering test apparatus further including:
a target board for supporting the test specimens for exposure to the concentrated solar radiation;
a concentrating device for directing concentrated solar radiation intensity on to the target board for exposing the test specimens; and
an apparatus for adjusting the temperature of the test specimens to the desired temperature.

168. The method as recited in claim 167, wherein the temperature control system includes:
a feedback device mounted to the target board for exposure to the concentrated solar radiation and generating a test signal responsive to a temperature thereof and representative of a test specimen temperature;
an input device for continuously generating a dynamic reference signal representative of a complex temperature cycle of an end-use application of the material; and
a controller connected to the input device and the feedback device; the controller responsive to the dynamic reference signal and the test signal for generating a control signal representative of the desired temperature for selectively controlling the apparatus in order to control adjustment of the temperature of the test specimens to the desired temperature, the adjustment being generally increased when the test specimen temperature is greater than the desired temperature, and the adjustment being generally decreased when the test specimen temperature is less than the desired temperature, and the adjustment being generally maintained constant when the test specimen temperature is substantially equal to the desired temperature.

169. The method cited by claim 168, wherein the input device is one of a temperature sensitive component, an apparatus for replaying a recorded environment temperature cycle, an apparatus for generating a complex temperature cycle and a non-contact monitoring device.

170. The method recited by claim 168, wherein the feedback device is one of a temperature sensitive component and a non-contact monitoring device.

171. The method as recited in claim 168, wherein the apparatus includes an air circulation device for moving ambient air over the target board, said air circulation device including an electric motor and a fan powered by the electric motor for creating a flow of ambient air.

172. The method as recited in claim 168, wherein the feedback device is connected in a heat conductive relationship to a panel mounted to the target board.

173. The method as recited in claim 168, wherein the feedback device further includes a black coating overlying the feedback device and the panel for absorbing the solar radiation intensity impinging thereon.

174. The method as recited in claim 168, wherein the apparatus includes a base contiguous with the test specimens and at least one fin which extends from the base into an air tunnel having a fan for moving air therethrough in order to dissipate heat from the specimen to air moved through the air tunnel by the fan.

175. The method as recited in claim 174, wherein the apparatus is a metallic heat sink.

176. The method as recited in claim 168, wherein the apparatus includes a base contiguous with the test specimens, at least two legs which extend from the base into an air tunnel having a fan for moving air therethrough in order to dissipate heat from the test specimens to the air moving through the air tunnel, a top connected to each leg having a first end and a second end and a voltage source applied across the first and second ends of the top.

177. The method as recited in claim 176, wherein adjacent legs are constructed of dissimilar semiconductor material.

178. The method as recited in claim 168, wherein the apparatus includes a flexible walled vessel containing a coolant adequate to adjust the desired temperature of the test specimens wherein the flexible walled vessel conforms to the test specimens as a result of the coolant disposed therein.

179. The method as recited in claim 178, wherein the flexible walled vessel is operatively connected to an inlet in communication with a coolant source and an outlet regulated to remove the coolant from the flexible walled vessel at a desired rate.

180. The method as recited in claim 178, wherein the coolant is selected from the group consisting essentially of refrigerated air, ethylene glycol, fluorocarbon refrigerants, alcohol, refrigerant gases and fluids used for heat exchange.

181. The method as recited in claim 152, wherein the offset is one of an absolute offset, a proportional offset, a function offset and no offset.

182. The method as recited in claim 162, wherein the controller further includes an offset device for applying the offset to the desired temperature.

183. The method as recited in claim 182, wherein the offset is one of an absolute offset, a proportional offset, a function offset and no offset.

184. The method as recited in claim 168, wherein the controller further includes an offset device for applying an offset to the desired temperature.

185. The method as recited in claim 184, wherein the offset is one of an absolute offset, a proportional offset, a function offset and no offset.

186. The method as recited in claim 152, wherein each group includes at least one natural accelerated weathering test apparatus from each set.

187. The method as recited in claim 152, wherein the plurality of groups includes:
a first group having test specimens at a first offset from the desired temperature;
a second group having test specimens at a second offset from the desired temperature; and
a third group having test specimens at a third offset from the desired temperature.

188. The method as recited in claim 187, wherein the first, second and third offsets are each one of an absolute offset, a proportional offset, a function offset and no offset.

189. The method as recited in claim 152, wherein the plurality of arrays includes:
a first array having test specimens exposed to a first preselected wavelength range;
a second array having test specimens exposed to a second preselected wavelength range; and
a third array having test specimens exposed to a third preselected wavelength range.
